(19) United States
(12) Patent Application Publication
(10) Pub. No.: US 2024/0186525 A1
(43) Pub. Date: Jun. 6, 2024

(54) ULTRATHIN POLYMER FILMS AS PROTECTIVE COATINGS FOR BATTERY ELECTRODES

(71) Applicant: CORNELL UNIVERSITY, Ithaca, NY (US)

(72) Inventors: Lynden A. ARCHER, Ithaca, NY (US); Rong YANG, Ithaca, NY (US); Sanjuna STALIN, Ithaca, NY (US); Shuo JIN, Ithaca, NY (US); Peng-Yu CHEN, Ithaca, NY (US)

(73) Assignee: CORNELL UNIVERSITY, Ithaca, NY (US)

(21) Appl. No.: 18/552,566

(22) PCT Filed: Mar. 28, 2022
(86) PCT No.: PCT/US2022/071389

§ 371 Date: Sep. 26, 2023

Related U.S. Application Data
(60) Provisional application No. 63/166,802, filed on Mar. 26, 2021.

(51) Int. Cl. H01M 4/62; H01M 4/04; H01M 10/0525

(52) U.S. Cl. CPC H01M 4/628; H01M 4/0428; H01M 10/0525

(57) ABSTRACT

The invention provides an electrode having a conformal polymer layer disposed thereon, wherein the conformal polymer layer has a thickness of 3 to 10,000 nm and includes: a polymer comprising one or more zwitterionic moieties; and/or fluorinated polymer. Also provided are energy storage devices comprising the inventive electrode, methods of preparing the electrode and the energy storage device, and further methods, including methods of enhancing conformality and/or elasticity of a conformal polymer layer on an electrode.

### CROSS-REFERENCE TO RELATED APPLICATIONS

This application claims priority to U.S. provisional application No. 63/166,802, filed Mar. 26, 2021, the entire contents of which are hereby incorporated by reference herein.

### GOVERNMENT LICENSE RIGHTS

This invention was made with government support under: IIP-1919013 awarded by the National Science Foundation. The United States Government has certain rights in the invention.

### FIELD OF THE INVENTION

This invention relates to, inter alfa, zwitterionic and/or fluorinated copolymers used as coatings for electrodes, to compositions comprising the copolymers, to methods of preparing the copolymers, and to methods employing the copolymers.

### BACKGROUND

The transition toward a sustainable energy future relies on the development of effective and economic energy storage technologies. However, hurdles associated with deleterious reactions at electrodes of energy storage devices stand in the way of facilitating a sustainable path forward.

Batteries having configurations with metallic anodes (such as lithium), with their ultra-high specific capacity of 3,860 mAh g⁻¹ are attractive as they exceed energy density values of 500 Wh kg⁻¹ when paired with state-of-the-art high-voltage Ni-rich cathodes. However, batteries such as Lithium Metal Batteries (LMBs) are not readily available today due to various challenges posed by complex interfacial phenomena particularly at the metallic anode/electrolyte interface, that impacts electrodeposition morphology, reversibility, and safety of the battery. Due to the highly reactive and reducing nature of alkali metal anodes, a heterogenous corrosion layer, known as the solid electrolyte interphase (SEI), forms on the anode surface due to chemical and electrochemical reactions between the metal and electrolyte components consisting of compounds such as Li₂O, LiF, Li₂O₃ and other semi-carbonates and alkoxides. During battery recharge, these heterogenous interphases produce hotspots where preferential lithium electrodeposition occurs, causing lithium to deposit in a non-planar, porous and mossy fashion, loosely termed as dendrites. Over time, the weak mechanical properties of the SEI causes it to rupture and reform continuously due to large volume changes at the anode caused by the growing dendrites, consuming more electrolyte and electrochemically active lithium in the process. While the growth of dendrites across the interelectrode spacing poses a safety issue in the form of short circuits, consumption of electrolyte and electrochemically active lithium leads to capacity fade and eventual battery failure.

Other metal ion batteries also suffer from deleterious effects, including dendritic growth, at electrodes. For example, aqueous rechargeable Zn-ion batteries, based on water-electrolyte, possess unparalleled advantages in terms of low-cost, high safety, rich zinc resources, making Zn⁻ ion batteries an ideal next-generation energy storage system. However, aqueous electrolyte possesses inherent limitations for both anodes and cathodes. In aqueous solutions, Zn²⁺ cations are solvated by highly polarized water molecules, which gives rise to aqua ions (Zn(OH₂)₆)²⁺. Such cation-solvent interaction has a profound influence on the pH of the resultant solutions, further facilitating a series of side reactions, such as hydrogen evolution, Zn(OH)₂ and ZnO formation, etc., and the dendrite growth at Zn anode. On the other hand, it is formidable to assess an aqueous Zn battery system in view of the poor stability of cathode materials. Layered materials are generally used as cathode materials, nevertheless, the easy dissolution of the intermediated materials (after cations insertion) in the aqueous electrolyte highly limits its cycling ability.

Thus, a need exists for improved energy storage devices and electrodes that are better protected and have reduced susceptibility to harmful reactions that sacrifice battery operation and life.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this application, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, embodiments of the present invention satisfy the need for, inter alfa, improved energy storage devices and electrodes that are better protected and have reduced susceptibility to harmful reactions that sacrifice battery operation and life. In particular, embodiments of the invention provide a thin, conformal polymer layer that protects electrodes, including by suppressing side reactions and reducing deleterious effects thereof, such as dendritic growth. In some embodiments, the invention provides a zwitterionic polymer interphase that enables planar deposition of lithium and/or high reversibility of the anode. In some embodiments, the zwitterionic interphases alter the coordination environment of the lithium cation and in turn modify the redox reaction kinetics at the electrode surface favorably, resulting in stable lithium electrodeposition in both early and late stages of growth.

In a first aspect, the invention provides an electrode comprising a conformal polymer layer disposed thereon, wherein the conformal polymer layer has a thickness of 3 to 10,000 nm and comprises:
a polymer comprising one or more zwitterionic moieties; and/or
a fluorinated polymer.

In a second aspect, the invention provides an energy storage device comprising, as a first electrode, an embodiment of the electrode according to the first aspect of the invention, and wherein the device further comprises a second electrode and a separator interposed between the first electrode and the second electrode.

In a third aspect, the invention provides a method of preparing the electrode according to the first aspect of the invention, or the energy storage device according to the second aspect of the invention, the method comprising depositing the polymer layer on an electrode via a solvent-free polymerization technique (for example, via iCVD).

In some embodiments of the inventive method, depositing the polymer layer comprises:
placing the electrode in an iCVD reactor under vacuum condition;
flowing into the reactor in parallel or in sequence a plurality of materials comprising:
   an inert carrier gas;
   an initiator; and
   constituent monomers of the polymer (including, optionally, a crosslinker), thereby forming polymer layer on the electrode via iCVD; and
      optionally exposing the polymeric layer to a negatively charged functional moiety.

In some embodiments of the inventive method, said exposing the polymer layer to a negatively charged functional moiety results in functionalizing a pendant moiety (e.g., in a

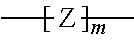

repeat unit) with the at least one negatively charged functional moiety.

In some embodiments, said exposing the polymer layer to a negatively charged functional moiety comprises exposing the polymer layer to a compound capable of functionalizing a moiety in the polymer with a moiety comprising a carboxylate anion, a sulfonate anion, phosphonate anion, or an oxygen atom.

In some embodiments, said exposing the polymer layer to a negatively charged functional moiety comprises exposing the polymer layer to 1,3-propane sultone (PS).

In some embodiments, said exposing the polymer layer to a negatively charged functional moiety comprises exposing the polymeric layer to 1,3-propane sultone (PS), thereby forming a pyridine-based (or other nitrogen-comprising heteroaryl ring-based) sulfobetaine zwitterionic functional group. In some embodiments, the sulfobetaine zwitterionic functional group is comprised within a

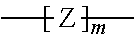

repeat unit.

In a fourth aspect, the invention provides a method of preparing the electrode according to the first aspect of the invention, or the energy storage device according to the second aspect of the invention, the method comprising depositing the polymer layer on a substrate via a solvent-free polymerization technique (e.g., iCVD), then transferring the polymer layer to the electrode.

In a fifth aspect, the invention provides a method of enhancing conformality and/or elasticity of a conformal polymer layer on an electrode, the method comprising depositing the polymer layer on the electrode via a solvent-free polymerization technique, wherein the conformal polymer layer has a thickness of 5 to 1,000 nm and comprises:
a polymer comprising one or more zwitterionic moieties; and/or
a fluorinated polymer.

### BRIEF DESCRIPTION OF THE DRAWINGS

FIG. 1 depicts a schematic diagram that explains the synthesis scheme of embodiments of zwitterionic polymers.

FIG. 2 shows SEM images of lithium electrodeposits (1 mAh/cm²) under zwitterionic polymer coatings of different thickness values. 1 M LiPF₆ in EC/DMC/DEC with 10% FEC was used as the electrolyte and the current density is 1 mA/cm².

FIGS. 3A-D show: (A) Cyclic Voltammetry of bare and coated copper electrodes at a slow scan rate of 0.1 mV/s, (B) Representative Nyquist plots for the LTO∥Copper (Ammonium-ZW coated) cells post chronoamperometry measurements at different reductive potentials vs Li/Li⁺, (C) Interfacial impedance values obtained from fitting the Nyquist plots with an equivalent circuit model (D) Coulombic Efficiency values of the different working electrodes when paired with two kinds of electrolytes, obtained using the Aurbach protocol.

FIG. 4 shows deposit morphology of lithium electrodeposits in the early nucleation stages in the presence of poly(DMAEMA), poly(DMAEMA-co-DVB) and derivatized poly(DMAEMA-co-DVB) coating. The polymers were synthesized using iCVD on polished stainless steel current collectors to eradicate substrate roughness effects and the images were analyzed using Image J. The histograms of analyzed images are reported below the SEM images.

FIG. 5 shows deposit morphology of lithium electrodeposits on coated (top row) and uncoated (bottom row) electrodes for different capacities during the growth stage. Current collector substrates include copper foils and 3D microporous copper electrodes (right most in box). All experiments utilized a standard 1 M LiPF₆ electrolyte with 10% Fec additive.

FIG. 6 depicts a schematic of an embodiment of iCVD technology, showing: (i) introduction of vaporized monomers, carrier gas and initiators; (ii) formation of free radicals by passing the initiator molecules through the heated filament; (iii) physisorption of monomers on the cooled substrate; and (iv) free-radical polymerization of the adsorbed monomers to form functional polymer thin films.

FIG. 7 depicts results from plate-strip cycles for a symmetric cell comprising aqueous 1 M ZnSO₄ electrolyte at a current density of 40 mA cm⁻², showing stable performance for over 9000 cycles. (Up) SEM images of pristine Zinc metal (left) and pPFDA coated Zinc metal (right) after 100 cycles. (Down)

FIG. 8 shows results from a transference number experiment of Zn|Zn symmetric cells using 150 nm pPFDA coated Zn electrodes or pristine Zn electrodes in 1 M ZnSO₄ aqueous electrolyte.

FIG. 9 depicts a voltage profile for the 1^{st}, 2000^{th}, 5000^{th}, 10000^{th} and 12000^{th} charge and discharge cycles of Zn∥MnO₂ cell containing 1 M ZnSO₄ electrolyte (left) and discharge capacity retention and coulombic efficiency over 12000 cycles for Zn∥MnO₂ cell embodiment.

FIG. 10 shows the molecular structure of the monomer candidate for an embodiment of high-performance aqueous Zn-ion battery.

FIG. 11 shows experimental results from analysis of SEM images of lithium nuclei deposited on electrodes coated with embodiments of fluorinated polymeric interphases of different thicknesses.

### DETAILED DESCRIPTION OF THE INVENTION

In the following and attached description, reference is made to the accompanying drawings and text that form a part hereof, and in which is shown by way of illustration specific embodiments which may be practiced. These embodiments are described in detail to enable those skilled in the art to practice the invention, and it is to be understood that other embodiments may be utilized and that structural, logical and electrical changes may be made without departing from the scope of the present invention. The following and attached description of example embodiments is, therefore, not to be taken in a limited sense, and the scope of the present invention is defined by the appended claims.

Hydrocarbon refers to any substituent comprised of hydrogen and carbon as the only elemental constituents. Unless otherwise specified, hydrocarbyl groups may be optionally substituted. An unsubstituted hydrocarbon may be referred to, e.g., as a “pure hydrocarbon”. The term hydrocarbon includes alkyl, cycloalkyl, polycycloalkyl, alkenyl, alkynyl, aryl and combinations thereof. Examples include phenyl, naphthyl, benzyl, phenethyl, cyclohexylmethyl, camphoryl and naphthylethyl. In some embodiments, hydrocarbon groups are aliphatic. In some embodiments, hydrocarbon groups are aromatic. In some embodiments, a hydrocarbon group may have from 1 to 50 carbon atoms therein (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 carbon atoms).

Unless otherwise specified, an “alkyl” group is intended to include linear, branched, or cyclic hydrocarbon structures and combinations thereof. A combination would be, for example, cyclopropylmethyl. Lower alkyl refers to alkyl groups of from 1 to 6 carbon atoms. Examples of lower alkyl groups include methyl, ethyl, propyl, isopropyl, butyl, s- and t-butyl and the like. In some embodiments, alkyl groups are those of C₂₀ or below (i.e., C₁₋₂₀ alkyl). Cycloalkyl is a subset of alkyl and includes cyclic hydrocarbon groups of from 3 to 8 carbon atoms. Examples of cycloalkyl groups include c-propyl, c-butyl, c-pentyl, norbornyl and the like. Unless otherwise specified, an alkyl group may be substituted or unsubstituted.

An “alkenyl” group refers to an unsaturated hydrocarbon group containing at least one carbon-carbon double bond, including straight-chain, branched-chain, and cyclic groups. In some embodiments, an alkenyl group has 1 to 12 carbons (i.e., 1, 2, 3, 4, 5, 6, 7, 8, 9, 10, 11, or 12 carbons). Lower alkenyl designates an alkenyl group of from 1 to 7 carbons (i.e., 1, 2, 3, 4, 5, 6, or 7 carbons). Unless otherwise specified, an alkenyl group may be substituted or unsubstituted.

An “alkynyl” group refers to an unsaturated hydrocarbon group containing at least one carbon-carbon triple bond, including straight-chain, branched chain, and cyclic groups. Preferably, the alkynyl group has 1 to 12 carbons. The alkynyl group may be substituted or unsubstituted.

Aryl and heteroaryl (or aromatic and heteroaromatic moieties, respectively), mean (i) a phenyl group (or benzene) or a monocyclic 5- or 6-membered heteroaromatic ring containing 1-4 heteroatoms selected from oxygen (O), nitrogen (N), phosphorus (P), or sulfur (S); (ii) a bicyclic 9- or 10-membered aromatic or heteroaromatic ring system containing 0-4 heteroatoms selected from O, N, P, or S; or (iii) a tricyclic 13- or 14-membered aromatic or heteroaromatic ring system containing 0-5 heteroatoms selected from O, N, P, or S. The aromatic 6- to 14-membered carbocyclic rings include, e.g., benzene, naphthalene, indane, tetralin, and fluorene and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole. As used herein aryl and heteroaryl refer to residues in which one or more rings are aromatic, but not all need be.

Li-ion batteries (LIBs) have largely facilitated daily life since their discovery. However, the limited specific energy of LIBs (SE_{LIB}=200-250 Wh kg⁻¹) has cast the spotlight on rechargeable batteries that employ metallic anodes. Configurations with metallic anodes like lithium, with their ultra-high specific capacity of 3,860 mAh g⁻¹ are attractive as they exceed energy density values of 500 Wh kg⁻¹ when paired with state-of-the-art high-voltage Ni-rich cathodes. These Lithium Metal Batteries (LMBs) are however not readily available due to various challenges posed by complex interfacial phenomena particularly at the metallic anode/electrolyte interface, that impact electrodeposition morphology, reversibility, and safety of the battery.

The propensity of alkali metal anodes like Li metal to form dendrites originates from the high electronegativity of Li, which causes the spontaneous formation of decomposition products such as Li₃, Li₂O, LiOH, LiF, other semi-carbonates, alkoxides etc. due to chemical and electrochemical redox reactions between the lithium metal anode and the electrolyte components such as carbonate/ether based molecules commonly used as solvents and the salt anion . This leads to the formation of a heterogenous corrosion layer or electrolyte/electrolyte interphase, known as the solid electrolyte interphase (SEI), that leads to the preferential electrodeposition of lithium metal during the charge cycle on certain hot spots within the SEI possessing higher conductivity-leading to the nucleation of the aforementioned dendrites.

During battery recharge, these heterogenous interphases produce hotspots where preferential lithium electrodeposition occurs, causing lithium to deposit in a non-planar, porous and mossy fashion, loosely termed as dendrites. Overtime the weak mechanical properties of the SEI causes it to rupture and reform continuously due to large volume changes at the anode caused by the growing dendrites, consuming more electrolyte and electrochemically active lithium in the process. While the growth of dendrites across the interelectrode spacing poses a safety issue in the form of short circuits, consumption of electrolyte and electrochemically active lithium leads to capacity fade and eventual battery failure.

Precise control over the composition and properties of the SEI is highly desired for overcoming the chemical and mechanical instabilities at the electrode/electrolyte interface and thereby achieving stable and high-performance LMBs. Several attempts have been reported towards stable interphases that enable planar and non-porous lithium electrodeposits through electrolyte engineering that comprises (i) electrolyte additives such as fluoroethylene carbonate, vinylene carbonate, lithium nitrate etc. that fundamentally alter the composition of the interphase by forming a highly conductive, homogenous and/or mechanically stable SEI, (ii) design of solid/composite electrolytes that exhibit favorable mechanical and ion transport properties that can arrest physical instabilities that lead to dendrite growth, (iii) high concentration or localized high concentration electrolytes whereby the cation solvation structure is modified to reduce the activity of solvent molecules and in turn prevent their decomposition products in the SEI, or novel design of artificial interphases which tune ion transport and reaction kinetics at the interface while accommodating volume changes. Controlling these complex redox reactions at the electrode/electrolyte interface through such task-specific, functional artificial interphases has been of key interest recently to the community as the advantages of this approach compared to electrolyte engineering is two-fold: 1) The overall configuration of the cell is unaltered and largely adaptable for scale-up and 2) Designing and implanting a stable artificial interphase with controlled properties and compositions allow structure-property relationships to be well-defined and correlated with electrodeposit morphology, directing future materials design for improved LMB performance. Tailoring the electrode/electrolyte interface with polymer coatings is particularly attractive since the viscoelastic nature of polymers allow them to accommodate high levels of strains and volume changes at the anode.

Various methods and techniques have emerged for forming conformal polymeric interphases. However, most of these involve use of solvents that lead to undesirable surface tension effects which result in coating defects like dewetting, formation of pinholes and other types of non-uniformity, which invariably led to uncontrolled dendrite formation. There is also limited freedom to explore the effect of different chemical functionalities afforded by the polymeric interphase on dendrite formation and LIB performance due to the constraints imposed by polymer solubility, which is a prerequisite for a polymer to be casted as coating for anodes. Furthermore, thickness control is critical for artificial interphases.

Polymers containing zwitterionic moieties are attractive candidates for artificial interphases due to two main reasons: (i) zwitterionic polymers contain a high concentration of cationic and anionic groups along their backbone that can assist in the dissociation and conduction of ions at the electrode/electrolyte interface while maintaining overall charge neutrality that doesn't introduce new potential gradients; and (ii) zwitterionic salts have been previously used as electrolyte additives in polymeric electrolytes to improve ionic conductivity.

Based on that rationale and leveraging the advantages of the all-dry iCVD technique, embodiments of the present invention have ultrathin zwitterionic polymeric interphases that are shown to be exceptional in enabling planar lithium electrodeposition.

In a first aspect, the invention provides an electrode comprising a conformal polymer layer disposed thereon, wherein the conformal polymer layer has a thickness of 3 to 10,000 nm and comprises:
a polymer comprising one or more zwitterionic moieties; and/or
a fluorinated polymer.

As used herein with respect to the polymer layer, the term “conformal” means that the layer follows, or conforms to the contours of the underlying substrate on which it is deposited. When the polymer layer is deposited on a substrate (e.g., an electrode, current collector, etc.), the true shape of the substrate is unchanged.

As used herein, the term “polymer” includes co-polymers.

The conformal polymer layer has a thickness of 3 to 10,000 nm (for example, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, or 10,000 nm), including any and all ranges and subranges therein (e.g., 5 to 1,000 nm, 5 to 500 nm, etc.).

In some embodiments, the polymer layer is formed via a solvent-free polymerization technique. For example, in some embodiments, the polymer layer is formed via initial chemical vapor deposition (iCVD), which is a solvent-free polymerization technique that enables the one-step synthesis and application of functional polymer nanolayers with precisely controlled film thickness and complete retention of chemical functionalities. By avoiding solvents and undesirable surface tension effects, polymer film embodiments synthesized via iCVD form uniform and defect-free coverage on the metal anodes. Meanwhile, the absence of residual solvent or other additives prevent undesired side reactions and formation of their decomposition products of on the alkali metal electrode. iCVD is conducive toward the synthesis of artificial interphases also because of its rich library of functional monomers, which provides access to a plethora of precisely controlled physicochemical properties, ranging from viscoelastic linear polymers to stiff highly crosslinked polymers, from superhydrophobic fluoropolymers to hydrophilic zwitterionic polymers and hydrogels, and from charge-neutral hydrocarbon polymers to polymers affording either charge or both.

In some embodiments, the polymer layer comprises polymer material that is chemically and electrochemically stable against lithium metal anode while sustaining homogenous diffusion of lithium cations for charge transfer at the anode surface.

In some embodiments, the polymer layer is viscoelastic, thereby allowing a polymeric interphase to accommodate high levels of strains and volume changes at the anode compared to in-situ formed composite heterogenous interphases.

In some embodiments, the polymer layer is ionically conducting (e.g., an ionically conducting polymeric interphase).

In some embodiments, the polymer layer comprises an amphiphilic polymer having both hydrophobic and hydrophilic segments/portions. In some embodiments, the polymer layer simultaneously achieves high interfacial energy and ion conductivity for stable lithium nucleation and growth.

In some embodiments, the polymer layer leverages chemomechanical effects to suppress dendrite nucleation and growth.

In some embodiments, the polymer layer includes a polymer that comprises one or more zwitterionic moieties, or a polymer that otherwise has both positive (cationic) and negative (anionic) charges incorporated into its structure. In some embodiments, at least one of the one or more zwitterionic moieties comprises a pyridinyl, imidazolyl, ammonium, or carboxylic acid residue.

In some embodiments, the polymer layer comprises fluorine rich domains, which increase interfacial energy while maintaining similar conductivity values to layers that do not comprise fluorine. Such embodiments can be achieved by leveraging the unique compatibility of iCVD with perfluoro-polymers that are often insoluble and thus inaccessible via conventional solution-based coating techniques. Furthermore, the iCVD solvent-free synthesis technique avoids the undesirable surface tension effects commonly associated with fluorinated polymers. In some embodiments, to simultaneously achieve high interface energy and high ion conductivity, monomers with contrasting surface energies, such as superhydrophilic zwitterionic and superhydrophobic perfluoro- polymers, are copolymerized using iCVD into a homogenous film free of phase separation. Alternatively, depositions of perfluorpolymers (e.g., directly on the metal anode) and zwitterionic polymers (e.g., atop the perfluoropolymer layer) are performed sequentially to yield a polymeric interphase with chemical gradient in its cross-section. The all-dry iCVD technique enables the gradient interphase without defects caused by dewetting. These strategies overcome the fundamental tradeoff between ion-conductivity and surface energy and enable planar electrodeposition at the anode surface.

In some embodiments, the polymer layer includes a polymer that comprises a fluorinated polymer, for example, a perfluorinated polymer.

In some embodiments, the polymer layer comprises an amphiphilic perfluorinated zwitterionic co-polymer.

In some embodiments, the polymer layer is a single homogenous layer. In some embodiment, the polymer layer comprises multiple separate layers (e.g., 1, 2, 3, 4, 5, 6, etc. layers), each of which is optionally homogeneous.

In some embodiments, the polymer layer comprises a fluorinated polymer that contains units from a monomer of formula (I) or (II):

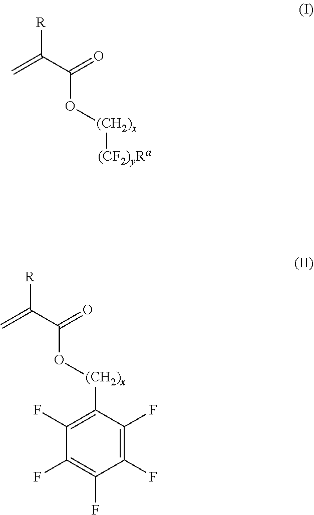

wherein
R is selected from hydrogen (H) and methyl (CH₃);
x is 0, 1, or 2;
y is 1-8 (1, 2, 3, 4, 5, 6, 7, or 8); and
R^{a} is selected from H and fluorine (F).

In some embodiments, the fluorinated polymer comprises units from one or more of the following monomers:

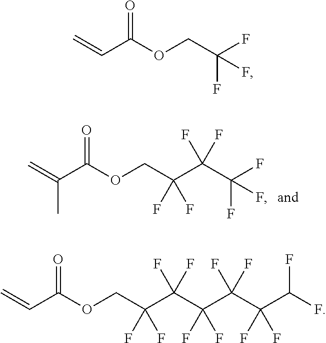

In some embodiments, the polymer layer comprises both a polymer comprising one or more zwitterionic moieties (or otherwise having both positive and negative charges incorporated into its structure), and a fluorinated polymer.

In some embodiments, the polymer layer comprises a hydrophobic polymer, and/or a hydrophilic polymer.

In some embodiments, the polymer layer comprises a hydrophobic fluoropolymer and/or a hydrophilic zwitterionic polymer.

In some embodiments, the polymer layer comprises a crosslinked polymer. Non-limiting examples of crosslinker monomers that can be used to form the crosslinked polymer include:

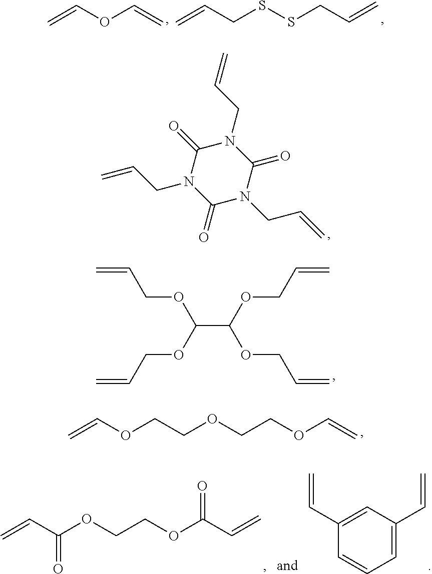

In some embodiments, the polymer layer comprises one or more structural unit(s) from one or more additional monomers.

In some embodiments, the polymer layer comprises a polymer as described in U.S. application Ser. No. 17/454,763 filed on Nov. 12, 2021.

In some embodiments, the polymer comprises repeat units of formulas:

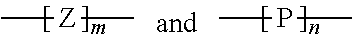

wherein
Z is a zwitterionic structural unit comprising at least one pendant heteroaromatic moiety, wherein the heteroaromatic moiety comprises a positively charged quaternary nitrogen atom, and wherein at least one negatively charged functional moiety is linked to the heteroaromatic moiety directly or through a linker, wherein the linker, where present, is an optionally substituted alkylene linker;
P is a structural unit comprising a hydrophobic moiety, said hydrophobic moiety being a linear, branched, or cyclic fluorine-substituted C₁-C₂₀ moiety;
m is an integer that is≥0;
n is an integer that is≥0 and
the sum of m+n≥1.

While

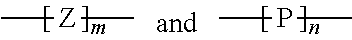

are referred to herein as repeat units, it will be readily appreciated by persons having ordinary skill in the art that if m or n, respectively, is 1, then such particular unit in the polymer is a single unit that does not repeat.

The repeat unit

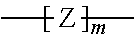

may be referred to herein as the repeat unit [Z]ₘ, and the repeat unit

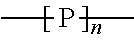

may be referred to herein as the repeat unit [P]ₙ.

Z is a zwitterionic structural unit comprising at least one pendant heteroaromatic moiety that comprises a positively charged quaternary nitrogen atom (e.g., a pyridine, imidazole, etc.). At least one negatively charged functional moiety is linked to the heteroaromatic moiety directly or through a linker, namely, an optionally substituted alkylene linker. In some embodiments, the linker is non-substituted. In other embodiments, the linker is substituted. For example, in some embodiments, the linker is substituted with alkyl or halogen (“halo”).

The at least one negatively charged functional moiety that is linked to the heteroaromatic moiety (e.g., comprising a pyridine or other nitrogen-containing heteroaryl ring, etc.) may be any art-accepted moiety that provides a negative charge. In some embodiments, the at least one negatively charged functional moiety comprises a carboxylate anion, a sulfonate anion, a phosphonate anion, or an oxygen (for example, in some embodiments where the oxygen is attached directly to a nitrogen atom of a heteroaryl ring—e.g., a pyridine ring—it may be attached directly to the nitrogen of ring). In particular embodiments, the at least one negatively charged functional moiety is a structural unit from 1,3-propane sultone (PS). In some embodiments, the at least one negatively charged functional moiety is —(CH₂)₃SO₃⁻.

P is an optionally present structural unit comprising a hydrophobic moiety, said hydrophobic moiety being a linear, branched, or cyclic fluorine-substituted C₁-C₂₀ alkyl moiety (having 1, 2, 3, 4, 5, 6, 7, 8, 9, 10, 11, 12, 13, 14, 15, 16, 17, 18, 19, or 20 carbon atoms, or any range or subrange therein).

In some embodiments, both Z and P are present, and the polymer is an amphiphilic copolymer.

In some embodiments, the hydrophobic moiety is or comprises a perfluoroalkyl substance (wherein each carbon atom in the chain is fully saturated with fluorine, i.e., carbon-fluorine bonds only), or a polyfluoroalkyl substance (wherein one or more carbon atoms in the chain also contains a carbon-hydrogen bonds). In some embodiments, the hydrophobic moiety is or comprises, e.g., a pentafluorophenyl (meth)acrylate.

In particular embodiments, the hydrophobic moiety is of the formula —CᵣFₛ, wherein r is less than or equal to 20 (i.e., 1, 2, 3, 4, 5, 6, 7, 8, 9, 10, 11, 12, 13, 14, 15, 16, 17, 18, 19, or 20), and s is less than or equal to 41 (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, or 41). In some embodiments, r is less than or equal to 10 (i.e., 1, 2, 3, 4, 5, 6, 7, 8, 9, or 10), and s is less than or equal to 21 (i.e., 1, 2, 3, 4, 5, 6, 7, 8, 9, 10, 11, 12, 13, 14, 15, 16, 17, 18, 19, 20, or 21). For example, a linear fully fluorinated C10 hydrophobic moiety would have the formula —(CF₂)₉CF₃, wherein r would be 10 and s would be 21. As will be readily apparent to a person having ordinary skill in the art, where any carbon atom of the hydrophobic moiety is not fully fluorinated, such carbon would have one or more hydrogen atoms attached thereto.

“m” and “n” designate the number of repeating units of [Z]ₘ and [P]ₙ, respectively.

In some embodiments, m and n are integers independently selected from 0 to 10,000 (e.g., 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, or 10000), including any and all ranges and subranges therein.

In some embodiments, the inventive copolymer comprises the structural unit:

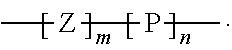

In some embodiments of the inventive copolymer, the repeat unit

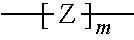

is a repeat unit of formula
wherein:

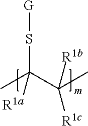

S is a heteroaromatic ring having a positively charged quaternary nitrogen atom (e.g., a pyridine ring, etc.);
G is a moiety comprising the at least one negatively charged functional moiety that is linked to the heteroaromatic ring; and
R^{1a}, R^{1b}, and R^{1c} are each individually selected from hydrogen, alkyl, phenyl, halo, hydroxyl, amino, nitro, and cyano.

In some embodiments, R^{1a}, R^{1b}, and R^{1c} are each independently selected from hydrogen and alkyl.

In some embodiments, R^{1a}, R^{1b}, and R^{1c} are each hydrogen.

In some embodiment of the inventive copolymer, the repeat unit

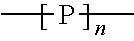

is a repeat unit of formula

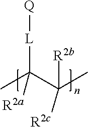

wherein
Q is the hydrophobic moiety;
L is not present or is a linking moiety; and
R^{2a}, R^{2b}, and R^{2c} are each individually selected from hydrogen, alkyl, phenyl, halo, hydroxyl, amino, nitro, and cyano;

In some embodiments, R^{2a}, R^{2b}, and R^{2c} are each independently selected from hydrogen and alkyl.

In some embodiments, R^{2a}, R^{2b}, and R^{2c} are each hydrogen.

In some embodiments, L is a linker comprising a bond, alkylene, amide, ester, ether, or disulfide moiety, or any combination thereof.

In particular embodiments, L is a linker —C(═O)O-alkyl (wherein the alkyl chain attaches to Q).

In some embodiments, L is a linker —C(═O)O(CH₂)ₜ, wherein t is an integer from 0 to 5 (i.e., 1, 2, 3, 4, or 5).

In some embodiments, the inventive copolymer further comprises a repeat unit from a crosslinking moiety X. The crosslinking moiety can be any art-accepted moiety. For example, in some embodiments, the crosslinking moiety X is selected from a unit of polymerized monomer selected from arylene, alkylene, phenylene, 1,4-phenylene, divinylbenzene, ethylene glycol dimethacrylate, ethylene glycol diacrylate, vinyl methacrylate, allyl methacrylate, maleic anhydride, 1,3,5-trivinyltrimethylcyclotrisiloxane and glycidyl methacrylate, or any combination thereof.

In some embodiments, the inventive copolymer comprises a repeat unit from a crosslinking moiety X, the repeat unit having the formula:

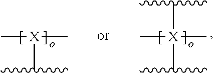

(which can be referred to both individually and collectively—i.e., meaning one and/or the other structure—herein as a repeat unit [X]ₒ) wherein o is an integer selected from 0 to 10,000 (e.g., 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, or 10000), including any and all ranges and subranges therein.

In some embodiments, the inventive copolymer comprises one or more structures of formula (i)-(vi):

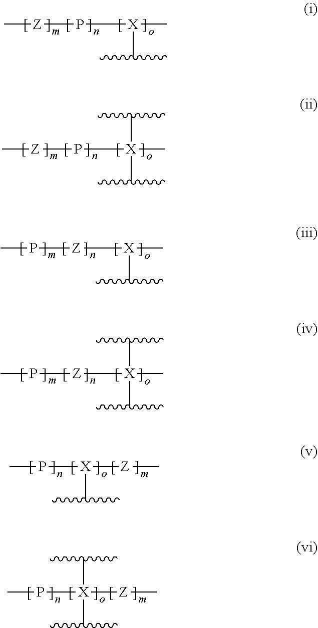

In some embodiments, the inventive copolymer comprises a first repeat unit of formula (I) and a second repeat unit of formula (II):

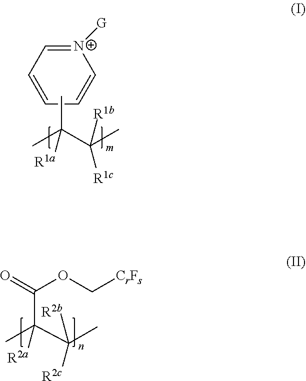

wherein:
G is a moiety as hereinbefore described comprising the at least one negatively charged functional moiety that is linked to the pyridine ring;
R^{1a}, R^{1b}, and R^{1c} are each individually selected from hydrogen, alkyl, phenyl, halo, hydroxyl, amino, nitro, and cyano;
R^{2a}, R^{2b}, and R^{2c} are each individually selected from hydrogen, alkyl, phenyl, halo, hydroxyl, amino, nitro, and cyano;
q is 0-4;
r≤10; and
s≤21.

In some embodiments of the inventive copolymer, the first repeat unit of formula (I) is of formula (IA):

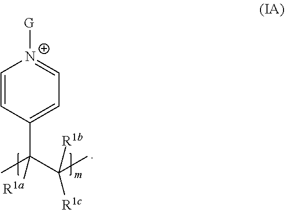

In some embodiments, G is —(CH₂)₁₋₆SO₃⁻ (e.g., —(CH₂)SO₃⁻, —(CH₂)₂SO₃⁻, —(CH₂)₃SO₃⁻, —(CH₂)₄SO₃⁻, —(CH₂)₅SO₃⁻, or —(CH₂)₆SO₃⁻).

In some embodiments, R^{1a}, R^{1b}, and R^{1c} are each individually selected from hydrogen and methyl.

In some embodiments, the pyridine in formula (I) or formula (IA) is not pyridine, but is any other nitrogen-containing heteroaryl ring.

In some embodiments, the inventive copolymer comprising a first repeat unit of formula (I) and a second repeat unit of formula (II) additionally comprises a repeat unit from a crosslinking moiety X. For example, the copolymer can comprise a repeat unit selected from:

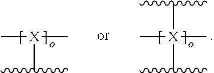

In some embodiments, the copolymer includes one or more structural unit(s) from one or more additional monomer(s).

In some embodiments, the sum of Z, P, and X (where present) repeat units in the inventive copolymer makes up 20 to 100 mol % (e.g., 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 100 mol %) of all units present in the copolymer. As will be apparent, where Z, P, and X (where present) make up 100 mol % of the copolymer, no other structural units from other monomers will be present.

In some embodiments, the [Z]ₘ repeat unit makes up 5 to 95 molar % (mol %) (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %), including any and all ranges and subranges therein, of units in the copolymer.

In some embodiments, the [P]ₙ repeat unit in the copolymer makes up 5 to 95 mol % (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %), including any and all ranges and subranges therein, of units in the copolymer.

In some embodiments, the [X]ₒ repeat unit in the copolymer makes up 0 to 90 mol % (e.g., 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %), including any and all ranges and subranges therein.

In some embodiments of the inventive copolymer Z, P, and X are selected from the structural units shown in the following embodiments, and/or the copolymer comprises one of the following structural units. Embodiments of the inventive copolymer include not only the following configurations, but also any combination of the depicted units from multiple embodiments as shown below and as described herein:

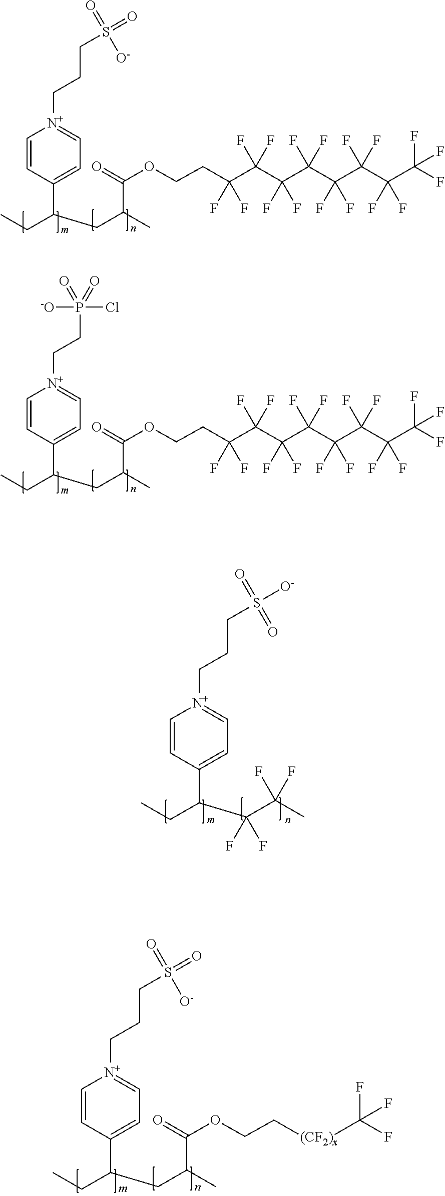

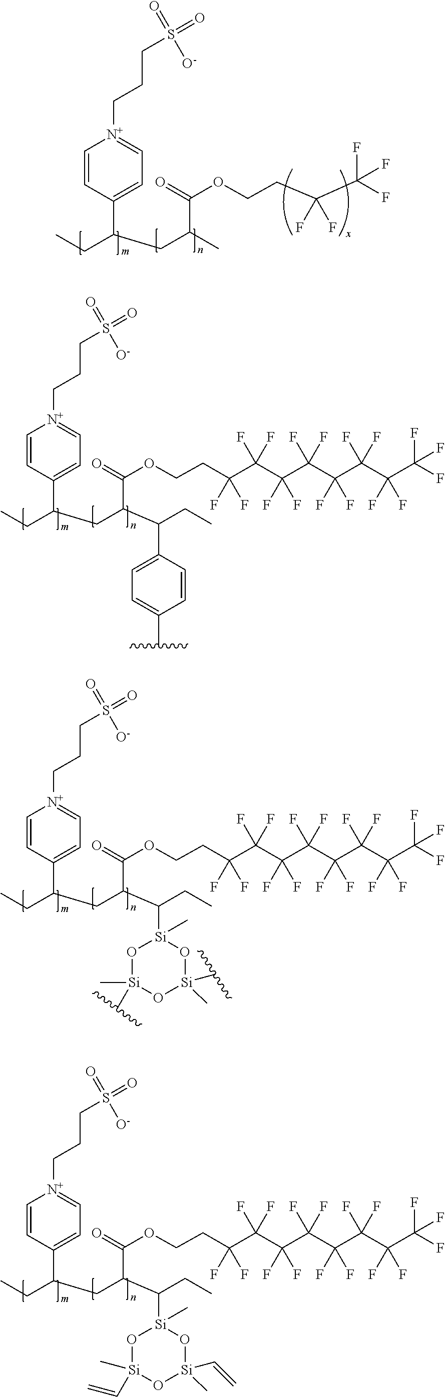

wherein x is an integer from 0 to 9 (i.e., 0, 1, 2, 3, 4, 5, 6, 7, 8, or 9).

In some embodiments, the polymer layer has a contrast in comonomer surface energies of at least 48 mN m⁻¹ (e.g., at least 48, 49, 50, 51, 52, 53, 54, 55, 56, 57, or 58 mN m⁻¹).

In some embodiments, the polymer layer has an average root mean square (RMS) roughness of 0.1 nm to 500 micron (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, 100000, 200000, 300000, 400000, or 500000 nm), including any and all ranges and subranges therein.

In some embodiments, the polymer layer is disposed directly on the electrode.

In some embodiments, the polymer layer is not disposed directly on the electrode.

In some embodiments, the polymer layer is disposed on a current collector.

In some embodiments, the electrode is a cathode.

In some embodiments, the electrode is an anode.

In a second aspect, the invention provides an energy storage device comprising, as a first electrode, an embodiment of the electrode according to the first aspect of the invention, and wherein the device further comprises a second electrode and a separator interposed between the first electrode and the second electrode.

In some embodiments, the energy storage device comprises an electrolyte, e.g., a liquid electrolyte.

In some embodiments, the energy storage device is a metal ion battery (e.g., a lithium ion battery or a zinc ion battery).

In a third aspect, the invention provides a method of preparing the electrode according to the first aspect of the invention, or the energy storage device according to the second aspect of the invention, the method comprising depositing the polymer layer on an electrode via a solvent-free polymerization technique (for example, via iCVD).

During certain embodiments, iCVD comprises heating thin filament wires, thus supplying energy to fragment a thermally-labile initiator, thereby forming a radical at moderate temperatures. The use of an initiator not only allows the chemistry to be controlled, but also accelerates layer growth and provides control of molecular weight and rate. In some embodiments, the energy input is low due to the low filament temperatures, but high growth rates may be achieved.

In some embodiments, the iCVD process takes place in a reactor. A variety of monomer species may be polymerized and deposited via iCVD; these monomer species are well-known in the art. In certain embodiments, the surface to be coated is placed on a stage in the reactor and gaseous precursor molecules are fed into the reactor; the stage may be the bottom of the reactor and not a separate entity. In certain embodiments, a variety of carrier gases (e.g., inert carrier gases) are useful in iCVD; these carrier gases are well-known in the art.

In a fourth aspect, the invention provides a method of preparing the electrode according to the first aspect of the invention, or the energy storage device according to the second aspect of the invention, the method comprising depositing the polymer layer on a substrate via a solvent-free polymerization technique (e.g., iCVD), then transferring the polymer layer to the electrode.

In a fifth aspect, the invention provides a method of enhancing conformality and/or elasticity of a conformal polymer layer on an electrode, the method comprising depositing the polymer layer on the electrode via a solvent-free polymerization technique, wherein the conformal polymer layer has a thickness of 5 to 1,000 nm and comprises:
a polymer comprising one or more zwitterionic moieties; and/or
a fluorinated polymer.

### EXAMPLES

The invention will now be illustrated, but not limited, by reference to the specific embodiments described in the following examples.

### Zwitterionic Polymeric Interphase Examples

### Synthesis of Copolymer Coatings and Derivatization:

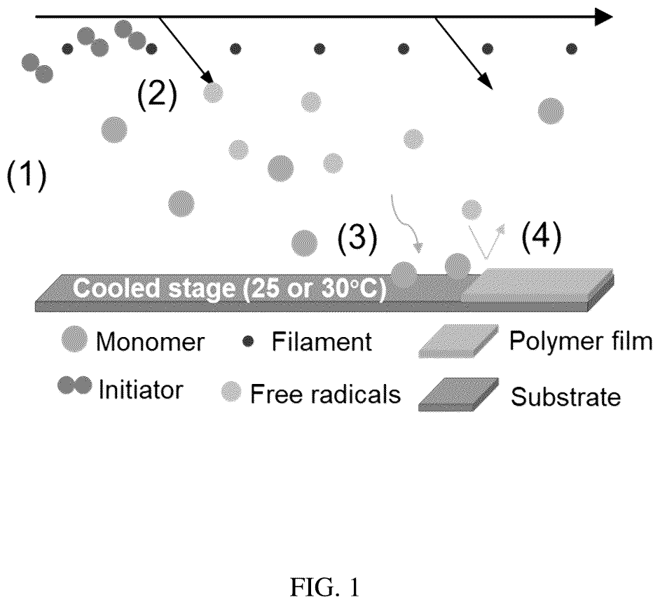

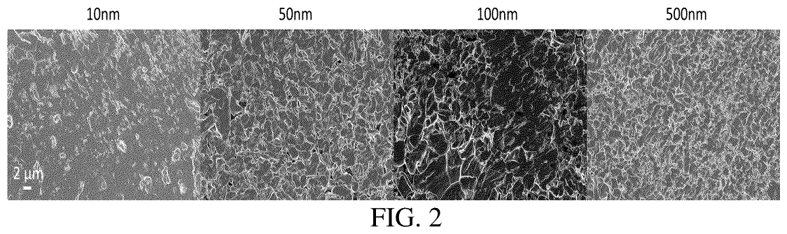

FIG. 1 depicts a schematic diagram that explains the synthesis scheme of the zwitterionic polymers from these examples. During the iCVD process, polymer coatings were created via free-radical polymerization mechanism. Monomers, argon carrier gas (not shown due to its chemical inertness), and initiator- tert-butylperoxide (TBPO) are introduced into a vacuum chamber where substrates to be coated were placed on a cooled stage (20-30° C.). The purpose of stage cooling is two-fold, i.e., to protect thermally labile substrates and to enhance the physisorption of monomers, which follows the BET isotherm. Free radicals to initiate the polymerization among the physiosorbed monomers are generated via homolytic cleavage of the initiator, TBPO, whose passing through an array of metal filaments, resistively heated to 230° C., supplies the energy for generating the radicals in the vapor phase. Free-radical polymerization subsequently proceeds upon surface impingement of the radicals, following an Eley-Rideal mechanism.

All the polymer coatings were created using iCVD technology in a custom-built cylindrical vacuum reactor (Sharon Vacuum Co Inc., Brockton, MA, USA). Thermal excitation of the initiators was provided by heating a 0.5 mm nickel/chromium filament (80% Ni/20% Cr, Goodfellow) mounted as a parallel filament array. Filament temperature was controlled by a feedback loop, whose reading came from a thermocouple attached to one of the filaments. The filament holder straddled the deposition stage that was kept at desired substrate temperatures using a chiller. The vertical distance between the filament array and the stage was around 2 cm. Depositions were performed on four kinds of substrates: Si wafers (P/Boron<100>, Purewafer, San Jose, CA, USA), copper foils, stainless steel sheets polished by aluminum slurry and 3D copper foams (from MTI Corp). Initiator (tert-butyl peroxide (TBPO, Sigma-Aldrich, 98%)) and monomers (1-vinylimidazole (Sigma-Aldrich, >=99%), 4-vinyl pyridine (4 VP, Sigma-Aldrich, 95%), 2-dimethylaminoethyl methacrylate (DMAEMA, Sigma-Aldrich, 98%) and divinylbenzene (DVB, Sigma-Aldrich, 80%) were used without further purification. During the iCVD depositions, TBPO and argon patch flow were fed to the reactor at room temperature through mass flow controllers at 0.6 sccm and desired flow rates (see below, deposition parameters), respectively. 1 VI, 4 VP, DMAEMA and DVB were heated to 70° C., 60° C., 75° C. and 65° C. in glass jars, respectively, to create sufficient pressure to drive vapor flow. Films were deposited at a filament temperature of 230° C. The total pressure of the chamber was controlled by a butterfly valve. In situ interferometry with a HeNe laser source (wavelength=633 nm, JDS Uniphase) was used to monitor the film growth on a Si wafer. The deposition parameters are listed below:

During the poly(1-vinylimidazole-co-divinylbenzene) depositions, flow rate of 1 VI and DVB were 2.0 and 0.2 sccm, respectively. The total flow rate was 2.8 sccm. The stage temperature was set to be 30° C. The chamber pressure was 500 mTorr. Under those conditions, the P_{M}/P_{M}^{sat} (the ratio of partial pressure of monomer to the saturated pressure under the stage temperature) of 1 VI was 0.37. The monomer to crosslinker ratio is 10:1.

During the poly(4-vinylpyridine-co-divinylbenzene) depositions, flow rate of 4 VP and DVB were 4.0 and 0.15 sccm, respectively. The total flow rate was 4.75 sccm. The stage temperature was set to be 25° C. The chamber pressure was 500 mTorr. Under those conditions, the P_{M}/P_{M}^{sat} of 4 VP was 0.25. The monomer to crosslinker ratio is 10:1.

During the poly(dimethylaminoethyl acrylate-co-divinylbenzene) depositions, flow rate of 4 VP and DVB were 2.0 and 0.15 sccm, respectively. The total flow rate was 2.75 sccm. The stage temperature was set to be 30° C. The chamber pressure was 500 mTorr. Under those conditions, the P_{M}/P_{M}^{sat} of DMAEMA was 0.32. The monomer to crosslinker ratio is 10:1.

In a second step, the coated substrates were fixed in a crystallizing dish (VWR) with 1 g of 1,3-propanesultone (Sigma-Aldrich, 98%). The crystallizing dish was placed inside a vacuum oven that was maintained at 25 Torr, 130° C. for 24 h to allow the 1,3-propanesultone vapor to completely react with the polymer coating. For the low zwitterionic fraction sample, the reaction temperature and time were reduced into 50° C. for 1 h for incomplete reaction.

TABLE 1
Reaction and deposition conditions for the zwitterionic polymers of this example

| | | DVB | TBPO | | | |
|---|---|---|---|---|---|---|
| | Monomer | flow | flow | Total | Stage | Filament |
| | flow rate | rate | rate | pressure | temperature | temperature |
| Material | (sccm) | (sccm) | (sccm) | (mTorr) | (° C.) | (° C.) |
| poly(4VP-co-DVB) | 4.0 | 0.15 | 0.6 | 500 | 25 | 230 |
| poly(VI-co-DVB) | 2.0 | 0.2 | 0.6 | 500 | 30 | 230 |
| poly(DMAEMA-co- | 2.0 | 0.15 | 0.6 | 500 | 30 | 230 |
| DVB) | | | | | | |

### 2. Methods:

Material Characterization: All coin cell assembly and air and water sensitive manipulations were carried out under dry argon conditions in an MBraun Labmaster glovebox. ¹³C, ⁷Li and ¹⁹F NMR spectra were collected Cornell Center for Materials Research (CCMR) on a Bruker AV III HD spectrometer with a broad band Prodigy cryoprobe.

Thickness Measurement: The accurate film thickness on the Si wafer substrates was measured post-deposition using a J. A. Woollam spectroscopic ellipsometry at three different incidence angles (65°, 70°,75°) using 188 wavelengths from 380 to 900 nm. The data were fit using a Cauchy-Urbach model.

AFM: Atomic force microscope (AFM) imaging was performed at Cornell Energy Systems Institute (CESI). The wafers w/ and w/o polymer coating were analyzed using an MFP-3D-Bio-AFM-SPM (ASYLUM Research, USA) in tapping mode. The taping mode was selected to avoid damaging polymer coatings with the AFM tip. The wafers with dimensions of 1 cm×1 cm were mounted on a stainless-steel sheet. A large scanning area of 20×20 μm² was chosen to provide the typical morphology feature. The tips possess a spring constant of 7.4 N/m and a fundamental frequency of 160 kHz (PPP-NCSTR). The average surface roughness was reported in terms of root mean square (RMS) measurements.

FTIR: Fourier transform infrared (FTIR) measurements were performed on a Bruker Vertex V80v vacuum FTIR system in transmission mode. A deuterated triglycine sulfate (DTGS) KBr detector over the rage of 4000 cm⁻¹ was adopted with a resolution of 4 cm⁻¹. The measurements were averaged over 128 scans to obtain a sufficient signal-to noise ratio. All the spectra were collected on Si wafer coated with 200 nm polymer thin films and baseline corrected after subtracting a background spectrum of Si wafer without coating.

Nanoindentation: Nanoindentation was performed using a Bruker TI 900 equipped with a diamond Berkovich indenter tip. The shape of the indenter tip was determined using a fused silica standard prior to testing using the Oliver and Pharr method. All samples were affixed to steel discs with Loctite® super glue and then mounted onto a magnetic stage. The sample surfaces were inspected using the optical microscope mounted within the nanoindenter and all four tested samples appeared to have smooth surfaces. In each sample, a 10×10 array of displacement-controlled indentations were performed with a 10 μm spacing between indents to ensure no mechanical interaction between tests. Each indentation consisted of a monotonic increase of the applied tip displacement over 15 s to a maximum depth of 150 nm, followed by a 15 s holding period at this depth to allow the indented material to equilibrate, followed by a monotonic decrease of the displacement to 0 nm over 20 s. The load-displacement curves for each indent were inspected and any clear outliers, which can be caused by hardware malfunctions or indenting into surface flaws, were discarded.

After the removal of outlier data, there were around 100 usable indentations per utilized sample. The reduced modulus (Eᵣ) and hardness (H) were calculated from the unloading portions of each indentation's load-displacement curve using the Oliver and Pharr method. The reduced modulus is a convolution of the elastic mechanical properties of both the sample and the diamond tip as shown in the relation below:

$$\frac{1}{{E}_{r}} = \frac{1 - {v}_{s}^{2}}{{E}_{s}} + \frac{1 - {v}_{i}^{2}}{{E}_{i}}$$

where Eₛ and vₛ are the Young modulus and Poisson ratio of the sample and Eᵢ and vᵢ are the same properties for the diamond indenter tip. As the properties of the diamond tip are known to be Eᵢ=1140 GPa and vᵢ=0.07, it is possible to calculate an elastic modulus which is solely a function of the properties of the sample, denoted the indentation modulus (E_{ind}).

$${E}_{ind} = \frac{{E}_{s}}{1 - {v}_{s}^{2}}$$

Electrochemical Testing: All electrochemical measurements were done using 1 M LiPF₆ in EC/DMC/DEC (Sigma Aldrich) as the electrolyte unless mentioned otherwise. Impedance measurements and chronoamperometry experiments were performed at Cornell Energy Systems Institute (CESI) with a Biologic SP-200 pontentiostat. For the chronoamperometry measurements lithiated LTO (half of the total capacity) was used as the counter and reference electrode while the coated/uncoated copper as the working electrode. The cell was held at each reducing potential for a total period of 3 hours. Coulombic efficiency measurements were performed using the Aurbach protocol: Coulombic efficiency tests were carried out by first a formation cycle by depositing 5 mAh/cm² and then stripping fully to 1 V at current 0.5 mA/cm². Then, a reservoir of 5 mAh/cm² Li is deposited, followed by 10 cycles of deposition, and stripping of 1 mAh/cm² Li from the Li reservoir, all at 0.5 mA/cm². Finally, the remaining Li is all stripped to 1 V and the CE is calculated from the amount stripped. Full cell cycling was done with NCM 622 cathodes (3 mAh/cm²) provided by Nohms Inc. and lithiated 3-D microporous copper electrodes (N:P-1:1). The electrolyte used was 0.6 M LiTFSI, 0.4 M lithium bis-(oxalato) borate (LiBOB, Sigma Aldrich), and 0.05 M lithium hexafluorophosphate (LiPF₆, Sigma Aldrich) in EC: DMC, previously reported to form stable CEI for nickel rich cathodes². Cyclic Voltammetry measurements for evaluating electrochemical stability were performed using coin cells at a scan rate of 0.1 mV/s with lithium as counter and reference electrode. Cyclic Voltammetry measurements for estimating exchange current density values were performed using a three-electrode setup with lithium foil as counter and reference electrodes and copper wire (0.05 cm in diameter) as working electrode. The copper wire was insulated with Kapton tape except for the exposed tip. 1 M LiPF₆ in EC/DMC/DEC was used as the electrolyte and the scan rate was fixed at 10 V/s.

XPS: X-ray Photoelectron Spectroscopy measurements were conducted at the Cornell Center for Materials Research (CCMR) using a Scienta Omicron ECSA 2SR spectrometer with operating pressure ca. 1×10⁻⁹ Torr. Monochromatic Al Kα x-rays were generated at 300 W (15 kV; 20 mA) with a 2 mm diameter analysis spot. A hemispherical analyzer determined electron kinetic energy, using a pass energy of 200 eV for wide/survey scans, and 50 eV for high resolution scans. A flood gun was used for charge neutralization of non-conductive samples. Data analysis was conducted by CasaXPS with Shirley background. All the samples were stored under vacuum at room temperature for a week before XPS analysis.

Polishing/Cleaning Method for nucleation study: The stainless-steel 304 substrate was polished to a surface roughness of Ra<10 nm through chemical mechanical polishing (CMP) method. The unpolished stainless-steel substrates were fixed in an Alumina slurry of 0.3 μm particles on a bed of Final-POL Adhesive Back Disc (Allied High Tech products) in a vibratory polisher at an amplitude of 50% for about 2 days. The polished stainless-steel substrates were further cleaned through ultrasonication in a bath of acetone for about 1 hour.

Electrode Characterization for nucleation study: SEM imaging was done at Cornell Center for Materials Research (CCMR) using Zeiss-Gemini-500-FESEM. 2032-type coin cells with the polished stainless-steel working electrodes and Li foil (Alfa Aesar 0.75 mm width) counter electrodes were assembled in an argon-filled glove box (MBraun). A Teflon O-ring of internal diameter 0.25 inches was used between the two electrodes and 200 μL of electrolyte was added to each cell. Celgard 3501 separator was used for Coulombic Efficiency and Full cell tests with 100 μL of electrolyte. Galvanostatic deposition was conducted using an 8-channel battery testing unit from Neware Instruments and MACCOR series 4000 battery tester system. For studying the early stage growth, the stainless-steel electrode was discharged to 0 V vs. Li/Li+ by applying 0.5 mA/cm² current, then charged back to 1.5 V at −0.5 mA/cm² to initialize SEI formation and remove surface impurities. Then, 1 mAh/cm² of lithium was passed galvanostatically at 1 mA/cm². After Li electrodeposition onto stainless-steel, the cells were opened in the Argon glove box and the stainless-steel electrodes were rinsed with fresh dimethyl carbonate and dried. Electrodes were mounted onto SEM stages and sealed in Argon filled transfer vessels for immediate SEM observation. Unavoidable contact with air was brief and may have slightly altered the surface features of the electrodeposited Lithium metal seen in SEM images. The images were captured at 2 kV with an aperture of 20 μm.

Image/Data Analysis: Nuclei sizes were measured using ImageJ software. Gaussian blurring to remove excessive noise, thresholding to restrict color contrast of images to black and white, and adjustable watershed to identify nuclei were performed. Between 100-500 particles were averaged for each current density and for every electrolyte composition. The radius of a Nuclei was calculated by assuming the nuclei to be hemispherical and the projected area was approximated to that of a circle.

### Synthesized Co-Polymers

The chemical structure of the different monomers that form the co-polymers are shown below in Scheme 1.

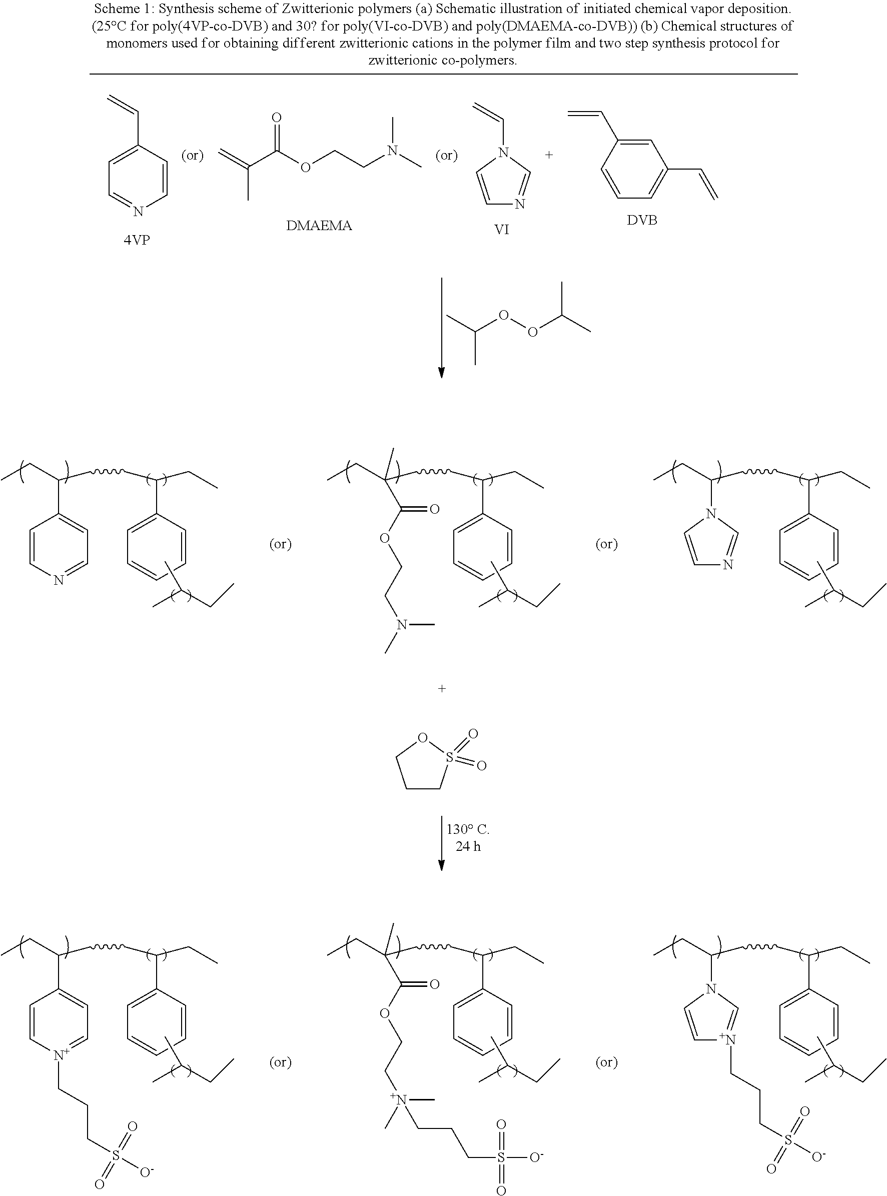

The zwitterionic polymer coatings were synthesized as described above. T tertiary nitrogen in poly(4-vinylpyridine-co-divinylbenzene)[poly(4VP-co-DVB)], poly(1-vinylimidazole-co-divinylbenzene)[poly(VI-co-DVB)] and poly(dimethylaminoethyl acrylate-co-divinylbenzene) [poly(DMAEMA-co-DVB)] was converted to a quaternized sulfobetaine group in a vapor-based derivatization step using 1,3-propanesultone, following the iCVD step. Reaction and deposition conditions used for the synthesis of the polymers are summarized above in Table 1.

Molecular structures of the as-deposited copolymers and the derivatized zwitterionic polymers were confirmed using Fourier transform infrared (FTIR), which indicated successful obtainment of the sulfobetaine zwitterionic moieties in the copolymers.

Characterization of the physical stability of polymer coatings on copper current collector. Delamination of the polymer coating from the current collector/metallic substrate is possible due to interaction with the bulk liquid electrolyte and swelling which is undesirable. In order to characterize the physical stability of the coatings on the copper substrates, NMR analysis was performed for a liquid electrolyte sample before and after exposure to the coated substrates for a period of 24 hours. Any dissolution or delamination would be detected in the bulk electrolyte post exposure. NMR spectrums of the electrolyte showed no additional peaks or shifts, indicating that the coatings were stable on the copper substrate on exposure to the liquid electrolyte.

Thickness, conformality, and further testing. Optimum thickness value is dependent on specific polymer properties such as ion diffusivity and shear modulus, is important when fabricating artificial interphase due to a delicate balance between resistance and elasticity, specifically for polymers with low Li⁺ ion diffusivity values. A series of zwitterionic polymers with different thickness values of 10, 50, 100, and 500 nm were deposited for electrodeposition experiments under galvanostatic conditions to understand the optimum thickness value for the zwitterionic polymers. The thickness of the as-deposited polymer coatings was characterized by ellipsometry and the data was fitted by the Cauchy-Urbach model.

FIG. 2 reports scanning electron microscopy (SEM) images of lithium electrodeposits (1 mAh/cm²) under different zwitterionic polymer coatings of thickness values 10, 50, 100, and 500 nm, paired with 1 M LiPF₆ EC/DMC/DEC as the bulk electrolyte. The lithium electrodeposits under the 10 nm coating showed the most consistent and stable morphology without grain boundaries compared to other thickness values. For further experiments, the coating thickness was set to 10 nm in all cases.

The uniformity and conformality of the ultrathin polymer films were also investigated. Copper foil demands the most stringent requirements for uniformity. The pristine copper foil exhibits rough surface morphology with characteristic scratches from top left to bottom right. SEM images confirmed that such features are perfectly maintained after 10-nm deposition with all three kinds of the polymer coatings.

Meanwhile, the polymer coatings do not contain extra surface features before and after the derivatization reaction, observed using Atomic Force Microscopy (the root-mean-square (RMS) roughness is 0.11±0.09 nm for silicon wafer, 0.06±0.05 nm for polymer coating before derivatization and 0.14±0.11 nm for polymer coating after derivatization). Mechanical properties of the polymer films were then investigated using nanoindentation with 1 μm thick deposited polymer films on wafers. Due to the slow deposition rate of the imidazole monomer, only the DMAEMA zwitterionic copolymer and the 4 VP zwitterionic copolymers were investigated.

Results showed that overall, the indentation modulus values increase after the derivatization reaction and are around 10 GPa, which is higher than the indentation modulus of Lithium metal.

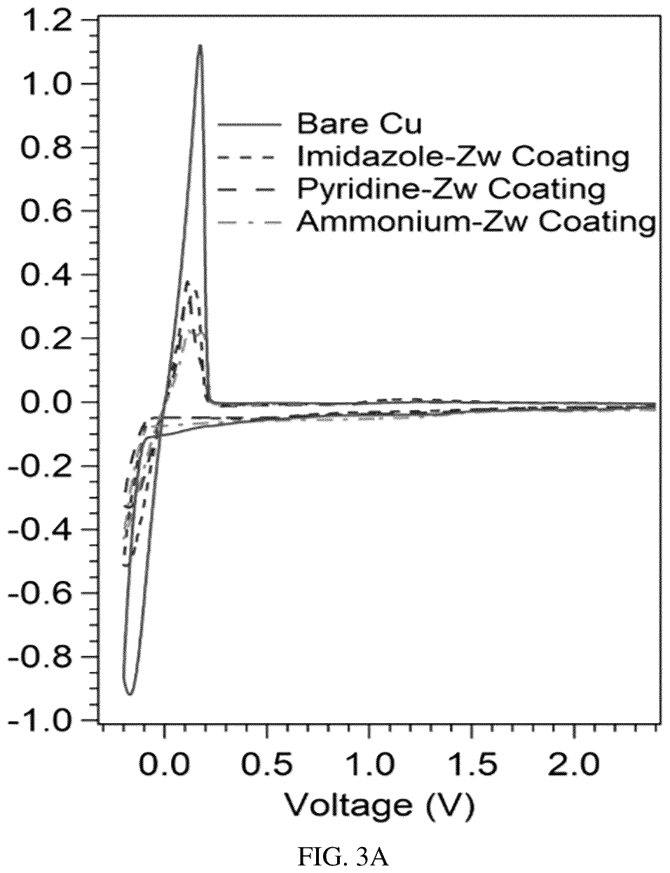

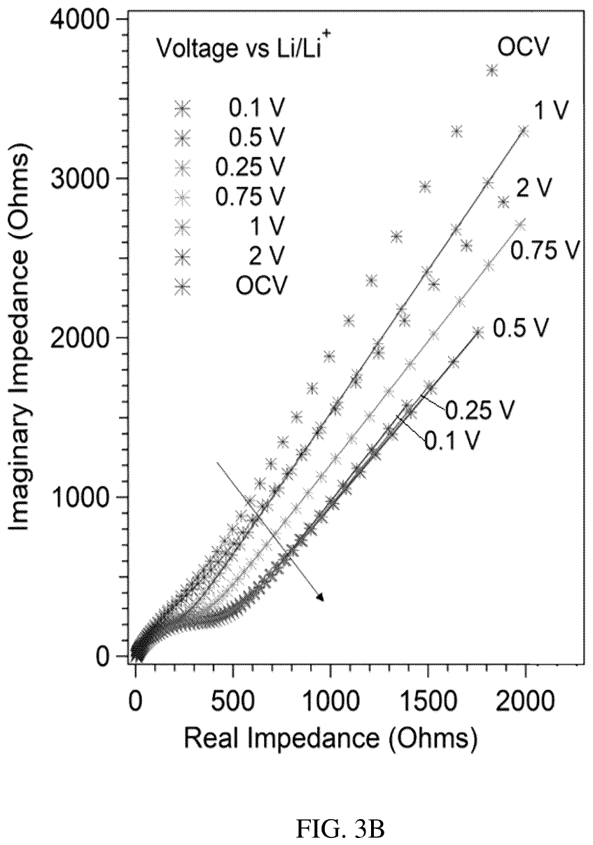

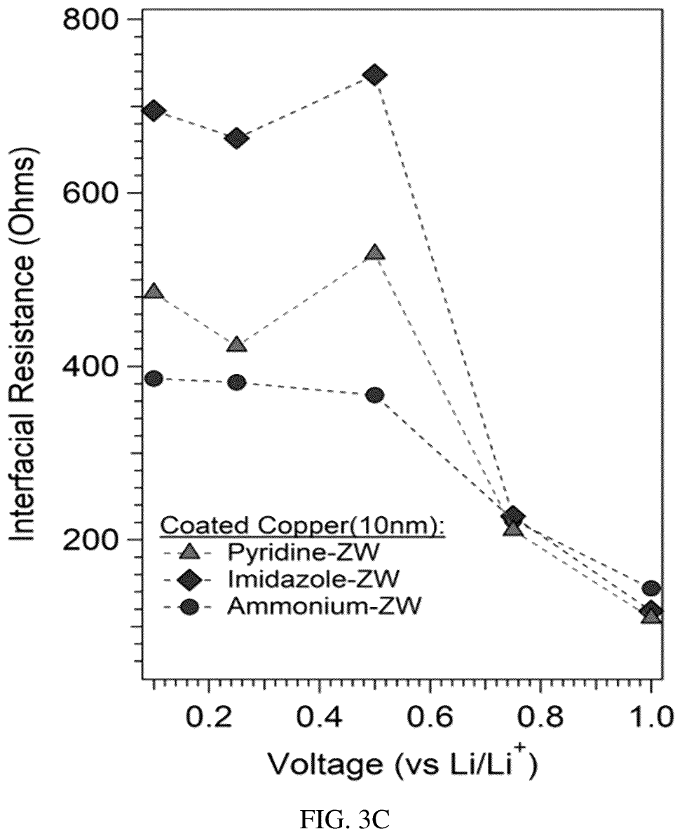

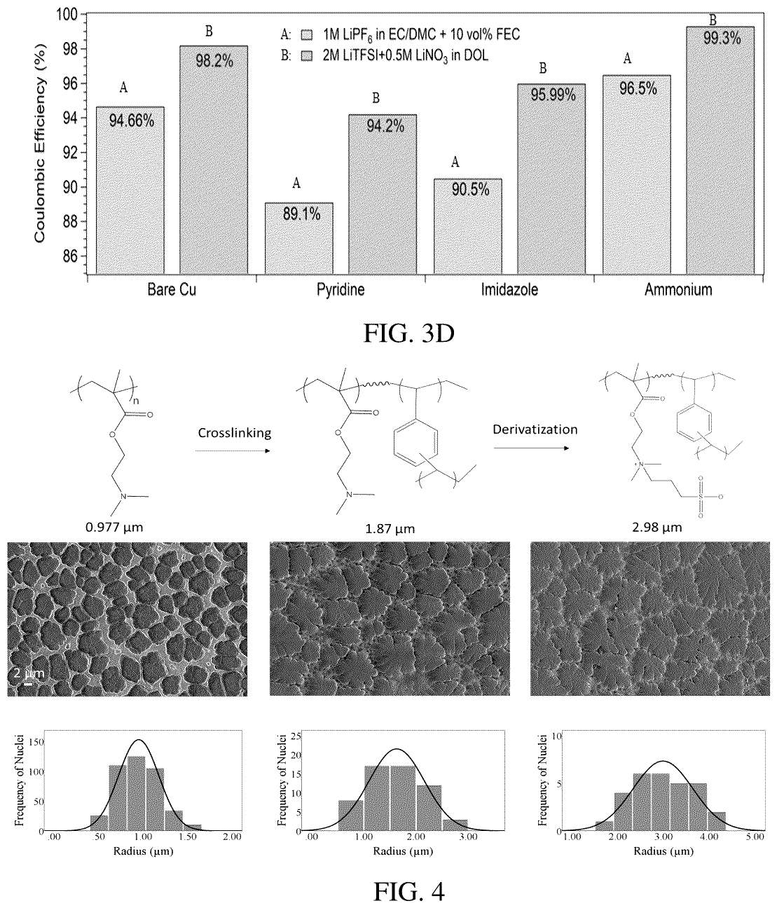

While designing artificial interphases, their intrinsic chemical and electrochemical stability and electrochemical stability is important to characterize to predict any potential degradation reactions on the metallic anode. To characterize the chemical stability of the zwitterionic groups against lithium metal anode, the derivatized acrylate monomers were incorporated as additives in the liquid electrolyte and subjected to static impedance measurements in symmetric cells. The experiments were performed with commercially available ammonium based zwitterionic salts. Under static conditions, the impedance values reached a steady state for the both the electrolyte samples containing zwitterionic salts indicating chemical stability. Electrochemical stability of the polymeric coatings was evaluated through cyclic voltammetry measurements at a moderately slow scan rate of 1 mV/s as reported in FIG. 3A.

The coated substrates were scanned from 2.5 V to −0.2V and the current evolution through plating and stripping of lithium metal was observed. No additional current peaks were observed compared to the uncoated copper substrate. However, the current magnitude was reduced by a large amount, indicating suppression of redox reactions at the electrode. Although cyclic voltammetry at moderately low scan rates is a reliable way of characterizing electrochemical stability of liquid systems, comparatively slow ion transport rates and kinetics of degradation reactions in solid systems might skew results towards higher cathodic stability limits. In order to decouple the stability from transport limitations and kinetic effect, chronoamperometry measurements were performed coupled with electrochemical impedance spectroscopy. 1 M LiPF₆ in EC/DMC/DEC was used as the electrolyte and lithiated LTO was used as the counter and reference electrode since the SEI contribution from LTO is low to negligible and all the interfacial contribution can be attributed to the working electrode. The coated or uncoated substrate was held at different reductive potentials vs Li/Li⁺ for 3 hours or until the reductive currents reached steady state and subsequently the impedance of the cell was measured. Representative raw EIS spectra at different reductive potentials for the ammonium based zwitterionic polymer coated substrate are shown in FIG. 3B. An interface formation, characterized by a semicircle in the EIS spectrum, is observed for reductive potentials below 1V. Fitting the spectra with an appropriate model allowed for decoupling the bulk, interfacial and charge transfer contributions. The extracted interfacial impedance for the three coatings is reported in FIG. 3C. While the ammonium based zwitterionic polymer coated substrate reaches a steady state impedance value beyond a certain potential, the imidazole and pyridine-based coating show much higher values of impedance that do not reach a steady state value as the reduction potential is decreased. These results correlate well with the coulombic efficiency measurements reported in FIG. 3D. Reversibility was accessed by pairing with a carbonate based and ether based electrolyte system that are commonly used in LMBs and it is clear that while the pyridine and imidazole-based coatings show lower reversibility compared to the uncoated electrode, the ammonium based zwitterionic polymer enhances reversibility in both the electrolyte systems studied. Based on observations, it is believed that the cations of the zwitterionic copolymers impact electrochemical stability similarly to that of ionic liquids.

Surface analysis using X-ray Photoelectron Spectroscopy (XPS) of electrodes cycled in a baseline carbonate electrolyte without any additives (1 M LiPF₆ in EC/DMC/DEC) shed light on the decomposition products formed on the surface after stripping and plating lithium. In general, all samples show presence of organic compounds such as fluorocarbons and inorganic salts such as carbonates and LiF. The N(1S) spectra show no nitrogen species on the uncoated electrode as expected. On the pyridine- or imidazole-based zwitterionic coatings, the N(1 s) scans showed higher concentration of tertiary amine species compared to quaternary nitrogen species. The ammonium-based coating however showed predominately quaternary ammonium species. While imidazole contains both quaternary and tertiary nitrogen post the derivatization reaction, the results hint at potential degradation of the organic nitrogen cation in the imidazole- and pyridine-based coatings, consistent with chronoamperometry and coulombic efficiency results (FIG. 3). After screening the zwitterionic copolymers for electrochemical stability, the derivatized poly(DMAEMA-co-DVB) coating was selected for the following studies to evaluate its impact on lithium electrodeposition stability and morphology.

Effect of the zwitterionic copolymer on early stage nucleation. To understand the effect of the zwitterionic copolymer on early stage nucleation of lithium electrodeposits, polished stainless steel current collectors were coated with poly(DMAEMA), poly(DMAEMA-co-DVB) and their derivatized products (i.e., zwitterionic polymers) to assess the effect of crosslinking and that of zwitterionic moieties on the nucleation process. Polished stainless steel current collectors are used to eliminate substrate roughness and a fixed capacity of 0.1 mAh/cm² was deposited on the coated substrates under galvanostatic conditions (1 mA/cm²). FIG. 4 shows the SEM images of the lithium nuclei under the three polymers along with the histograms reporting the distribution of nucleus sizes of the analyzed images. As observed from the extracted average nucleus size from image analysis, crosslinking leads to an increase in nucleus size and a more planar morphology, while incorporation of zwitterionic groups further increases the nucleus size and leads to a flatter morphology. It is possible that crosslinking reduced the dissolution of poly(DMAEMA) into the bulk electrolyte while also increasing the mechanical modulus of the polymer. Higher mechanical modulus and increase in diffusivity of ions has been reported to lead to an increase in nucleus size, correlating well with the results.

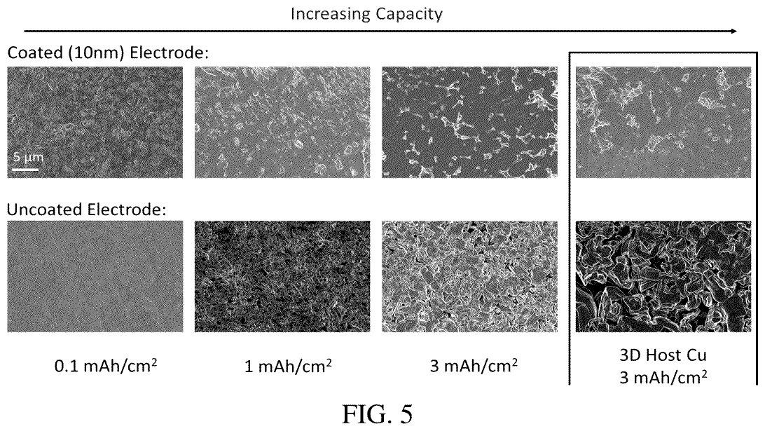

To understand the effect of the zwitterionic polymer coating at higher capacities on practical copper current collectors, lithium electrodeposits with capacities ranging from 0.1 to 3 mAh/cm² were imaged on coated and uncoated substrates as reported in FIG. 5. Compared to non-uniform, needle like deposition observed in case of the uncoated electrode, the polymer coated substrate enabled planar deposition for all capacities with no obvious grain boundaries. The effect on a 3D microporous copper current collector was also investigated. 3D copper current collectors are attractive as they can host higher capacities compared to planar substrates. However, the rough edges in such a microporous substrate typically leads to dendritic deposition. Testing revealed that the polymer coating leads to more closely packed, non-granular deposits compared to the uncoated electrode, indicating that the polymer coating can help alleviate the physical irregularities in the porous current collector.

Conclusion. In conclusion, the versatile iCVD technique was successfully utilized to deposit ultrathin zwitterionic copolymer films as protective coatings on current collectors to stabilize lithium electrodeposition. Through chronoamperometry and impedance measurements, it was found that the chemical functionalities, specifically the organic cations of the zwitterionic polymers, had a significant influence on electrochemical stability. The deposit morphology during early and late stages of growth was significantly more planar under the influence of the iCVD zwitterionic coatings. NMR experiments supported by a theoretical linear stability analysis indicate that the zwitterions actively participate in the solvation environment of the cation, thereby reducing the cation activity and in turn the exchange current density at the anode.

### Conformal Fluorinated Polymer Layer Examples

Layered materials are generally used as cathode materials in Zn-ion batteries, but the easy dissolution of the intermediated materials (after cations insertion) in the aqueous electrolyte highly limits its cycling ability.

Constructing a highly ion-conductivity hydrophobic nano-polymer layer can not only protect the cathode materials but also help suppress side reactions on both electrodes and suppress dendrite growth in the Zn anode.

To separate the water molecules which causes a series of side reactions with the electrode interface and also achieve high interfacial ion conductivity at the interface, a film preparation method with excellent conformality is highly desirable. Great conformality is even more indispensable when the polymer thickness is in nano-level, similar to the roughness. Especially, for cathode side, 3D porous structure electrode, a uniform and highly permeable coating method is necessary for surface protection. In this contribution, iCVD was used to construct a conformal semi-crystalline poly-1H,1H,2H,2H-perfluorodecyl acrylate (PFDA) nano-polymer interphase for both Zn anodes and layered material cathodes. The aqueous electrolyte facilitates the partial hydrolysis reaction so that some methacrylate acid unit was created to serve as the hoping site, which is crucial for high ionic conductivity.

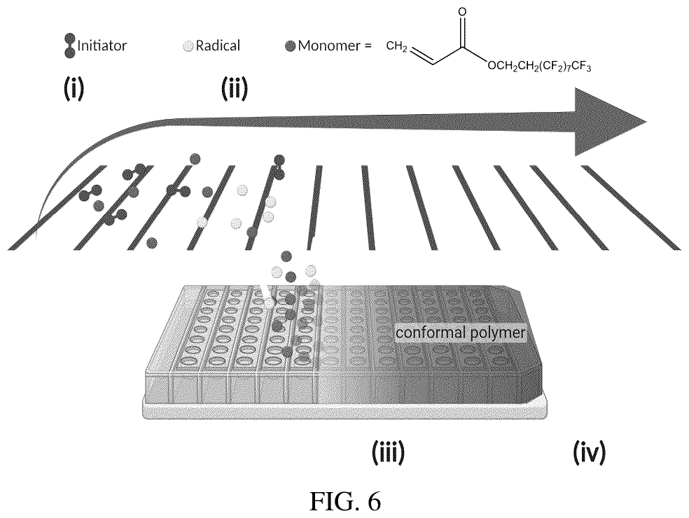

During the iCVD process, polymer coatings were created via the following mechanisms (FIG. 6): i) introduction of vaporized monomers, carrier gas (not shown in FIG. 6 due to its chemical inertness), and initiator, tert-butylperoxide (TBPO), into a vacuum chamber where substrates to be coated were placed on a stage maintained at room temperature; ii) physisorption of the monomers onto the temperature-controlled substrates; iii) formation of free radicals by the thermal decomposition of TBPO upon passing through an array of metal filaments, resistively heated to ˜200-300° C.; iv) free-radical polymerization of the surface-adsorbed monomers following an Eley-Rideal mechanism. Compared with the solution-based technique, vapor-based technique renders a great conformality.

The hydrophobicity and even the organization of polymer chain are determined by the repeating unit of the CF₂, which leads to further phase separation and self-organization of the fluorinated chains, due to the chemical incompatibility between the polymer backbone and the pendent groups. It has been shown that perfluorinated chains longer than seven CFₓ units form aggregates in an ordered lamellar structure called a smectic phase. For bulk pPFDA polymers, a smectic β phase was identified, where fluorinated chains are packed in bilayers. On the other hand, the crystallinity of the polymer could be regulated by spatial restriction which is achieved by controlling the thickness of the polymer film.

Polymer films of three thicknesses were formed, 50 nm, 150 nm, and 300 nm. X-ray diffraction (XRD) spectra revealed that little crystal is formed in the polymer film with 50 nm thickness. Great crystallinity is observed in 300 nm thick sample by the strong diffraction peak. The 150 nm thick film was a semi-crystallized film, as proven by a weak peak at 2θ=5.6°. Two-dimensional XRD image at 2θ=5.6° revealed a strong preferential orientation along the Z-axis for the bilayered structure of pPFDA polymer, with the fluorinated chains perpendicular to the zinc substrate. Such structure facilitates the in-plane ion transportation, enabling uniform ion distribution to suppress the dendrites formation.

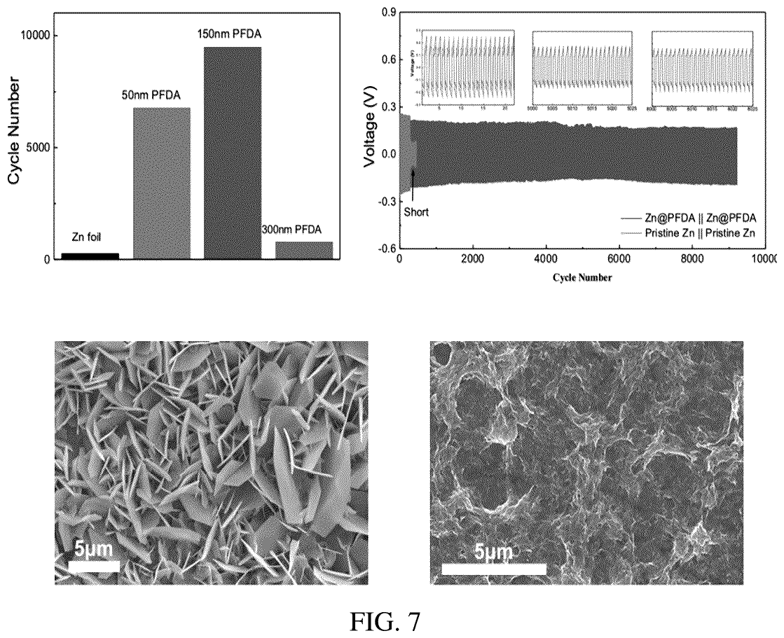

FIG. 7 shows results from a ‘strip-plate test’ in which symmetric Zn|Zn cells are charged and discharged sequentially for a certain capacity. It is clear that electrodes protected by pPFDA exhibit remarkably great cycling stability in comparison to pristine Zn electrode. At a current density of 40 mA cm⁻¹, the cells showed stable voltage profiles for more than 9000 cycles. However, the control symmetric cell with the same electrolyte without the pPFDA layer failed within 400 cycles. Under the same experimental condition, Zinc metal anode with 50 nm amorphous pPFDA, 150 nm semi-crystalized pPFDA and 300 nm crystalized pPFDA achieved the cycle number of 6800, 9500, and 800, respectively. Amorphous region of the polymer helps to achieve rapid ion transportation due to the relevance between ion migration to the mobility of the polymer segment. Crystal region contributes to high durability and stability of the polymer film. For 300 nm sample, high crystallinity and poor conductive channel make the film brittle and poorly ion-conductive, leading to a poor cycle stability. On the other hand, for the 50 nm pPFDA Zn electrode, a higher cycling stability could be achieved by increasing the crystallinity to make a highly stable polymer film. Above all, the 150 nm pPFDA coating is considered as the optimized thickness for further experiments.

FIG. 7 reports the morphology of the zinc anode surface using Scanning Electron Microscope (SEM) after 100 cycles of pristine Zn and pPFDA coated Zn. After 100 cycles, the polymer film stayed intact. The surface is rough, but no dendrites could be observed for cells based on the pPFDA coated Zn electrodes. In contrast, hexagonal platelet structure is formed on the surface of the pristine Zn anodes. The pPFDA coating exhibited excellent performance in cycling stability and regulating the deposition morphology.

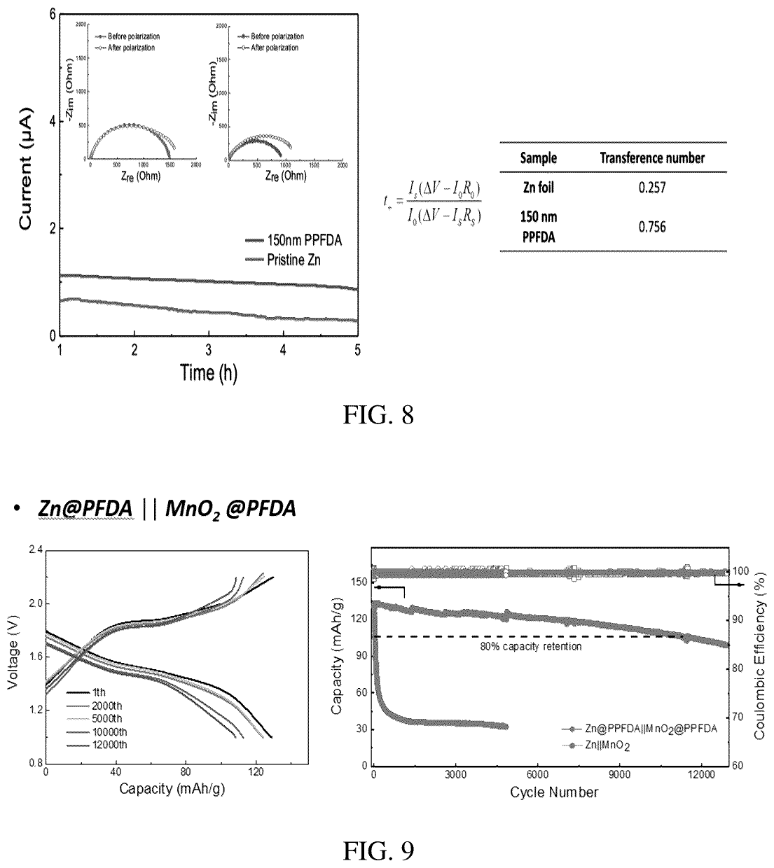

Owing to the strong coordination of Zn²⁺ with the water molecules, it would be difficult to achieve effective desolvation of (Zn(OH₂)₆)²⁺ without side reaction between H₂O and Zn electrode. A hydrophobic layer with great ionic conductivity would be an ideal approach to solve the problem without compromising the transportation kinetics. The small pore sizes and the hydrophobic domains in pPFDA membrane mean that at 150 nm thickness, it should be possible to retard transport of strongly polarized water and help to desolvate the water molecules. Meanwhile, the negative charged center created by the COO⁻ group provides an effective electrostatic shield, limiting the transport of negatively charged species at Zn electrodes but allows for facile transport of Zn²⁺ cations. This leads to a Zn²⁺ transference numbers approaching 0.756, three times larger than the control group (0.257), using aqueous ZnSO₄ electrolyte and simultaneously display high interfacial ionic conductivity (see FIG. 8).

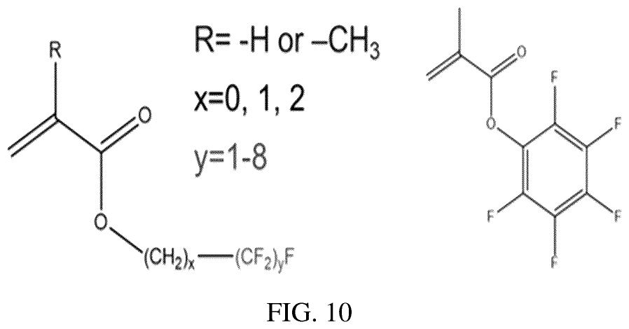

As a final assessment, Zn∥MnO₂ cells comprised of a Zn metal anode with MnO₂ cathode were created. The electrolyte was 1 M ZnSO₄ aqueous electrolyte. Layered MnO₂ is considered as a promising aqueous zinc battery cathodes material in terms of low cost, and high capacity. While the Zn⁺ and H⁺ insertion mechanism has been well studied, the material has a conventional problem, namely, severe dissolution and further damage to the layered structure, which greatly limits the cycle life. In this example, iCVD was used to create 150 nm coating of pPFDA on both MnO₂ cathodes and Zn anodes as hydrophobic and highly ion-conductive layer. The voltage profiles for the 1^{st}, 2000^{st}, 5000^{st}, 10000^{th} and 12000^{th} cycles are reported in FIG. 9 and cycle life in FIG. 10. It is seen that CE of the cells is high (>99.5%) and the discharge capacity is retained to more than 80% for at least 11,000 cycles at a rate of 8 mA/cm². In contrast, the control group fades to 80% capacity retention after only 35 cycles. The excellent performance improvements come from great suppression to the Mn ions dissolution.

The PPFDA nano polymer layer contributed to excellent performance on both cathode and anode parts due to its high hydrophobicity and high conductivity, which is attributed to its fluorine-rich moieties and hydrolyzable ester bond. This and other polymers are expected to promote the stable cycle of aqueous Zn-ion batteries. As shown in FIG. 10 (left), when the R group is H, it indicates that the monomer is acrylate derivative; when the R group is CH₃, it indicates that the monomer is methacrylate derivative. On the one hand, the choice R group has significance on the glass state transition temperature thus regulating the ionic conductivity, which is highly correlated to the chain mobility. On the other hand, a large R group inhibits the crystallization thus the mechanical and chemical stability could be regulated by the R group. In the side chain, the —(CH₂)ₓ—(x=0, 1, or 2) works as the soft linker to render regulatable chain mobility of the fluorine-rich pendent group. The chain length of the (CF₂)_{y} dominates the hydrophobicity as well as the organization of the polymer chain. Large y value contributes to low surface energy. Also, for y value larger than 7, the (CF₂)_{y} units form aggregates in an ordered lamellar structure. However, for y value smaller than 7, the polymer is generally amorphous polymer. The chain length of the —CF₂— endows the fluorinated polymer abundant and regulatable properties. Besides the fluoroalkyl pendant group, pentafluorophenyl pendant group is another promising choice due to its high hydrophobicity. Pentafluorophenyl methacrylate (PFM) is one nonlimiting promising candidate (see FIG. 10 (right)).

In conclusion, we have shown that a conformal pPFDA polymer layer can be used to protect the electrolyte from dendrite formation and ion dissolution, producing stable interfaces and extending the lifetime of metallic anodes and layered material cathodes in aqueous electrolyte. These observations demonstrate that inherent problems of aqueous electrolyte could be overcome using an artificial conformal hydrophobic polymer layer with high ionic conductivity, which isolated the water molecules and help (Zn(OH₂)₆)²⁺ to desolvation by what we hypothesize to be hydrophobicity, pore size and hoping site created by partial hydrolysis. This strategy is demonstrated in Zn∥MnO₂ cell and reveals a leap in cycle life from 35 to 11,000 cycles.

### Fluorinated Polymeric Interphase

Effect of a polymeric interphase on electrodeposition stability—Experimental Results: Fluorinated crosslinked polymers formed via a two-step synthesis protocol involving Thiol-Michael and Thiol-Ene reactions (see Scheme 2, below) were fabricated as a model SEI on polished current collectors to vary and decouple the effect of different physiochemical properties on lithium electrodeposition morphology.

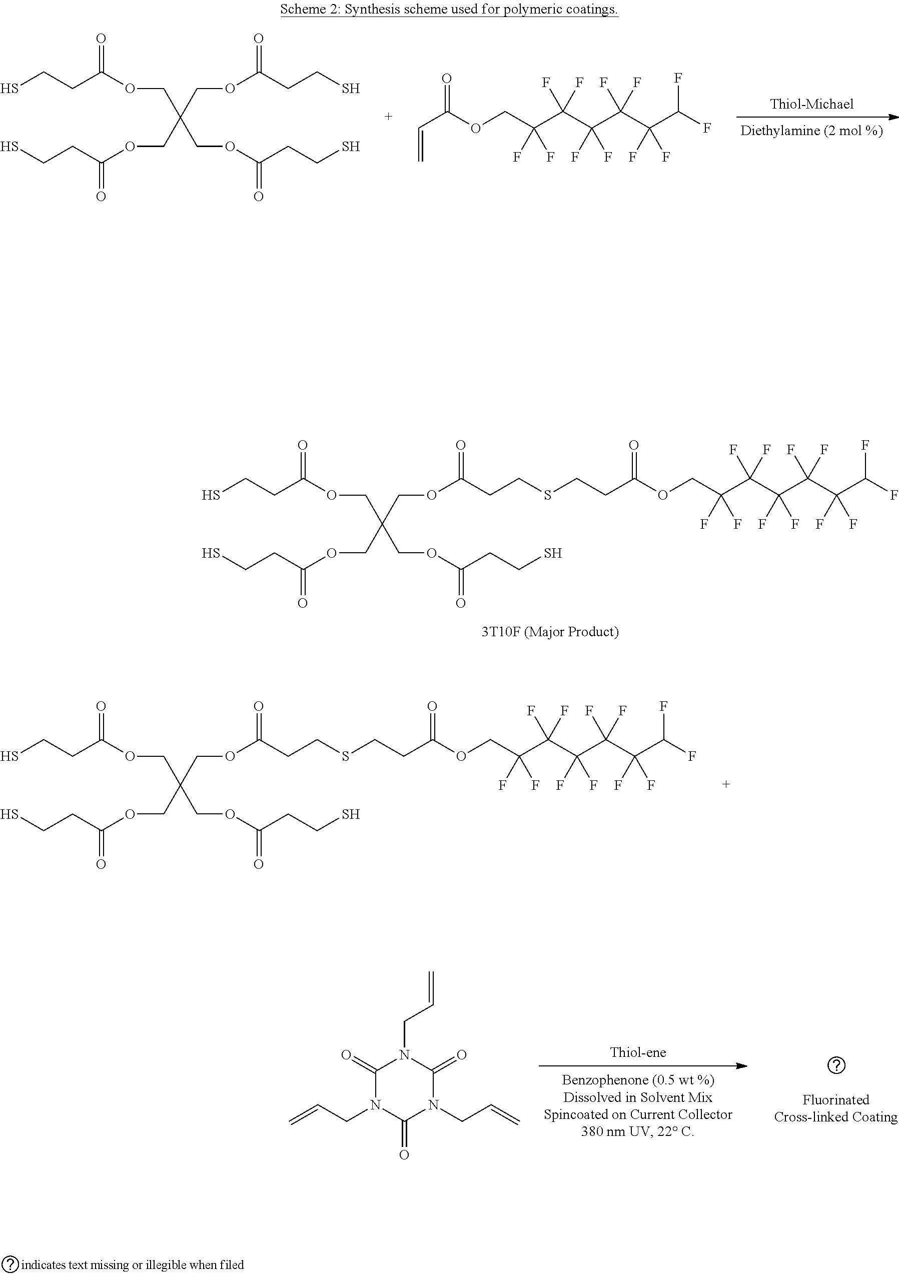 [SMILES: O=C(CCS)OCC(COC(=O)CCS)(COC(=O)CCS)COC(=O)CCS ; C=CC(=O)OCC(F)(F)C(F)(F)C(F)(F)C(F)(F)C(F)(F)C(F)F ; O=C(CCS)OCC(COC(=O)CCS)(COC(=O)CCS)COC(=O)CCSCCC(=O)OCC(F)(F)C(F)(F)C(F)(F)C(F)(F)C(F)(F)C(F)F ; O=C(CCS)OCC(COC(=O)CCS)(COC(=O)CCS)COC(=O)CCSCCC(=O)OCC(F)(F)C(F)(F)C(F)(F)C(F)(F)C(F)(F)C(F)F ; C=CCn1c(=O)n(CC=C)c(=O)n(CC=C)c1=O]

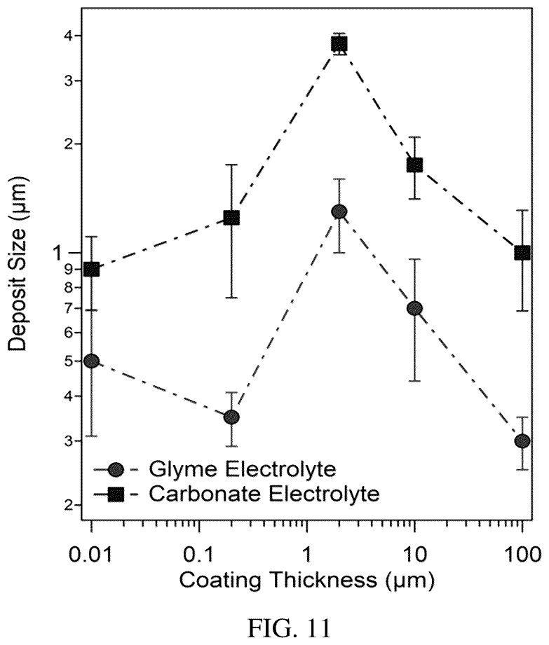

The thickness was first varied to assess its effect on the nuclei size. This is compared with experimentally obtained nuclei sizes for lithium electrodeposits on current collectors coated with polymeric interphases reported in FIG. 11, which shows experimental results from analysis of SEM images of lithium nuclei deposited on electrodes coated with embodiments of fluorinated polymeric interphases of different thicknesses. The experimental data obtained validated the theoretical prediction that an optimum thickness value is crucial to obtain higher deposit length scales. Additionally, it can be seen that increasing the diffusivity of the ions within the polymeric interphase increases the wavelength of the most unstable mode and reduces the growth rate. Molecular design of the interphase that can increase diffusivity of lithium ions is thus seen as favorable by the theoretical analysis to improve deposition stability. Tuning the chemistry and architecture of the polymeric interphase to increase the interfacial energy (lowering surface energy of the polymer) and shear modulus to augment surface tension forces that can planarize the electrodeposits was also proposed by the analysis. Careful modulation of the polymer composition by tuning the length of the fluorinated side chain and modifying the crosslinker architecture allowed for the systematic varying of surface energy values and shear modulus, respectively. The results are reported in Table 2.

TABLE 2
Deposit length scales of lithium nuclei formed under polymeric coatings of varying
surface energy values and varying shear modulus values.

| | Surface | Shear Modulus | |
|---|---|---|---|
| | Energy(mJ/m²) | (Mpa) | Nucleate Size(μm) |
| Fluoro-monomer | | | |
| 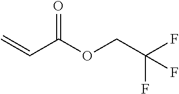 | 48 | 6 | 2 |
| 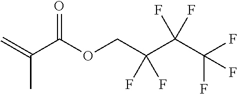 [SMILES: C=C(C)C(=O)OCC(F)(F)C(F)(F)C(F)(F)F] | 39 | 5 | 3 |
| 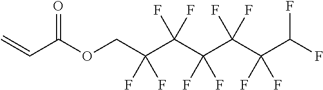 [SMILES: C=CC(=O)OCC(F)(F)C(F)(F)C(F)(F)C(F)(F)C(F)(F)C(F)F] | 30 | 4.5 | 3.4 |
| Crosslinker | | | |
| 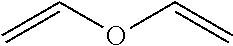 | 28 | 0.1 | 1.1 |
| 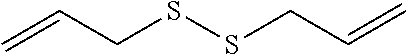 | 29 | 0.7 | 1.44 |
| 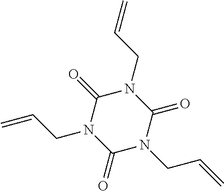 [SMILES: C=CCn1c(=O)n(CC=C)c(=O)n(CC=C)c1=O] | 30 | 6 | 3.4 |
| 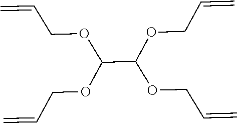 [SMILES: C=CCOC(OCC=C)C(OCC=C)OCC=C] | 30 | 10 | 3.55 |

Although the present invention has been described for the purpose of illustration, it is understood that such detail is solely for that purpose and variations can be made by those skilled in the art without departing from the spirit and scope of the invention which is defined by the following claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or device, composition, etc. that “comprises”, “has”, “includes” or “contains” one or more steps or elements possesses those one or more steps or elements, but is not limited to possessing only those one or more steps or elements. Likewise, a step of a method or an element of a composition or article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this application are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

The following statements are potential claims that may be converted to claims in a future application. No modifications of the following statements should be allowed to affect the interpretation of claims which may be drafted when this provisional application is converted into a regular utility application.

1. An electrode comprising a conformal polymer layer disposed thereon, wherein the conformal polymer layer has a thickness of 3 to 10,000 nm and comprises:
a polymer comprising one or more zwitterionic moieties; and/or
a fluorinated polymer.

2. The electrode according to claim 1, wherein the polymer layer has a thickness of 5 to 500 nm.

3. The electrode according to claim 1, wherein the polymer layer is disposed on the electrode via a solvent-free polymerization technique.

4. The electrode according to claim 1, wherein the polymer layer comprises one or more zwitterionic moieties, wherein at least one of the one or more zwitterionic moieties comprises a pyridinyl, imidazolyl, ammonium (e.g., quaternary ammonium), or carboxylic acid residue.

5-7. (canceled)

8. The electrode according to claim 1, wherein the polymer layer comprises a fluorinated polymer.

9. The electrode according to claim 8, wherein the fluorinated polymer is a perfluorinated polymer.

10. The electrode according to claim 8, wherein the fluorinated polymer comprises units from a monomer of formula (I) or (II): 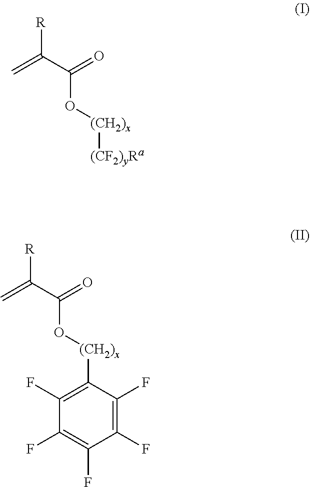
wherein
R is selected from H and CH₃;
x is 0, 1, or 2;
y is 1-8; and
R^{a} is selected from H and F.

11. The electrode according to claim 8, wherein the fluorinated polymer comprises units from a monomer selected from:

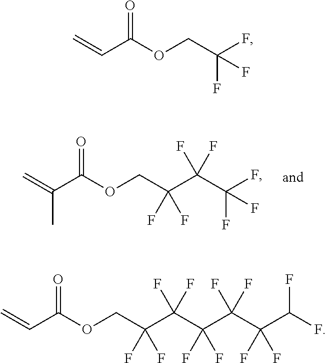

12. The electrode according to claim 1, wherein the polymer layer comprises a hydrophobic fluoropolymer and/or a hydrophilic zwitterionic polymer.

13. The electrode according to claim 1, wherein the polymer layer comprises a crosslinked polymer, which optionally comprises units from one or more of the following crosslinker monomers:

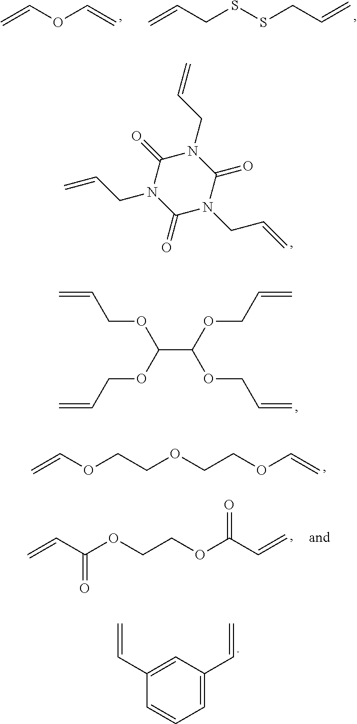

14. (canceled)

15. The electrode according to claim 1, wherein the polymer layer is disposed on a current collector on the electrode.

16-17. (canceled)

18. The electrode according to claim 1, wherein the fluorinated polymer comprises at least one fluorinated pendant group which comprises a perfluoroalkyl moiety and/or a perfluoroaromatic moiety, wherein the perfluoroalkyl moiety or the perfluoroaromatic moiety is linked to the backbone of the fluorinated polymer via a linker group that is optionally selected from —(CH₂)ₓ—, —(CF₂)ₓ—, 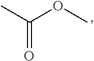
or any combination thereof, wherein x is selected from 0 to 6 (i.e., 0, 1, 2, 3, 4, 5, or 6).

19-21. (canceled)

22. The electrode according to claim 1, wherein the conformal polymer layer comprises a polymer having repeat units of formulas: 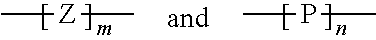
wherein
Z is a zwitterionic structural unit comprising at least one pendant heteroaromatic moiety, wherein the heteroaromatic moiety comprises a positively charged quaternary nitrogen atom, and wherein at least one negatively charged functional moiety is linked to the heteroaromatic moiety directly or through a linker, wherein the linker, where present, is an optionally substituted alkylene linker;
P is a structural unit comprising a hydrophobic moiety, said hydrophobic moiety being or comprising a linear, branched, or cyclic fluorine-substituted C₁-C₂₀ alkyl moiety;
m is≥0;
n is≥0; and
the sum of m+n≥1.

23. The electrode according to claim 22, wherein the polymer is an amphiphilic copolymer and m and n are both≥1.

24. The electrode according to claim 1, wherein the conformal polymer layer:
comprises a copolymer that comprises hydrophilic zwitterionic moieties from a first monomer and hydrophobic fluorinated moieties from a second monomer, or
is a single homogenous layer.

25. (canceled)

26. The electrode according to claim 1, wherein the conformal polymer layer comprises gradient interphase between a hydrophobic polymer (e.g., a fluorinated polymer) and a hydrophilic polymer (e.g., a conductive zwitterionic polymer).

27. The electrode according to claim 1, wherein the conformal polymer layer is free of phase separation and defects caused by dewetting.

28. An energy storage device comprising, as a first electrode, the electrode according to claim 1, and wherein the device further comprises a second electrode and a separator interposed between the first electrode and the second electrode.

29. The energy storage device according to claim 28, wherein the energy storage device is a metal ion battery (e.g., a lithium ion battery or a zinc ion battery).

30-31. (canceled)

32. A method of:
preparing the electrode according to claim 1; or
enhancing conformality and/or elasticity of a conformal polymer layer on an electrode;
said method comprising:
for preparing the electrode according to claim 1, depositing the polymer layer on an electrode via a solvent-free polymerization technique (e.g., iCVD), or on a substrate via a solvent-free polymerization technique (e.g., iCVD), then transferring the polymer layer to the electrode; or
for enhancing conformality and/or elasticity of a conformal polymer layer on an electrode, depositing the polymer layer on the electrode via a solvent-free polymerization technique (e.g., iCVD), wherein the conformal polymer layer has a thickness of 5 to 10,000 nm and comprises:
a polymer comprising one or more zwitterionic moieties; and/or
a fluorinated polymer.

33-34. (canceled)
